(19) United States
(12) Patent Application Publication
(10) Pub. No.: US 2025/0384382 A1
(43) Pub. Date: Dec. 18, 2025

(54) System and Method for Review of Quality Records for Regulatory and Quality Compliance

(71) Applicants: Dan Gebow, Bainbridge Island, WA (US); Dejan Cancarevic, Belgrade (RS); Jivan Singh Achreja, Raleigh, NC (US); Sarah E. Moeller, Minneapolis, MN (US)

(72) Inventors: Dan Gebow, Bainbridge Island, WA (US); Dejan Cancarevic, Belgrade (RS); Jivan Singh Achreja, Raleigh, NC (US); Sarah E. Moeller, Minneapolis, MN (US)

(21) Appl. No.: 18/741,320

(22) Filed: Jun. 12, 2024

(51) Int. Cl. G06Q 10/0639

(52) U.S. Cl. CPC G06Q 10/06395

(57) ABSTRACT

A computer-implemented method for automated review of quality records is disclosed as including the steps of operating a computer to access a plurality of electronic quality records; normalizing at least one electronic quality record of the plurality of electronic quality records to facilitate computer analysis thereof; sorting all electronic quality records into a predefined plurality of electronic quality record categories; operating the computer to automatically review at least some of the electronic quality records in at least some of the plurality of electronic quality record categories using a plurality of predefined sets of quality rules and logic, wherein each electronic quality record category is associated with a corresponding set of quality rules and logic; and classifying every reviewed electronic quality record as acceptable or not acceptable.

### BACKGROUND

This invention generally relates to methods and systems that automatically analyze the content of electronic quality records (including but not limited to scans of paper records) that are required as part of a regulated industry. Examples of a regulated industry include Aviation, Pharma/Medical Device R&D, Nuclear Power Plants, and Automobiles, amongst others. Quality records provide evidence that these regulated industries are functioning in a safe, compliant, legitimate, and transparent manner for the protection of the public, the institution's employees and contractors, and the environment. More specifically, this invention relates to systems for processing, interpretation, analysis and reporting in order to provide a comprehensive detection, identification, categorization, reporting, trending, oversight, and ability to control, mitigate, and prevent risks related to the record owners' potential deviations, violations, complaints, malfunctions, and regulatory, safety, and quality compliance issues.

In current practice, reviews of quality records or formal audits are conducted by an organization's internal personnel, a hired third party, or an inspector/investigator from a federal regulatory body (i.e. FDA, EPA, FAA, etc.) during audits and inspections. The regulated industries' standard is that these reviews are typically manual, performed by humans. The quality review process is usually conducted in person at the auditee's facility over a 3-to-5-day period which could last up to three months in the event of serious issues discovered. The auditor/inspector manually reviews a very small, sample subset of the available quality record set with reports estimating that approximately 90% of records generally go unchecked. Other studies have shown that records with significant quality issues are pervasive in aviation with recent incidences making national headlines. Similar rates of quality issues have been reported across clinical trials, medical product manufacturing, and healthcare, with extensive deviations not noticed until study end resulting in rejection of the entire study in multiple recent instances, or the product lifecycle from design through product release and post-market surveillance not including fast enough signal detection of product complaints and issues. Management's ability to perform legally required oversight has been limited to the small sample of records actually reviewed, sometimes resulting in missed signals which, if caught earlier, could have prevented expensive product rework and recalls, and safety issues. If detected earlier and more comprehensively could have been prevented with an earlier shifting of resources, creating significant cost savings, time savings, improved quality, and significant risk reduction. Teams have had to choose between time, cost, and quality, based on only a sample of records and information looked at over months or years. The product lifecycle documentation and review process from design, development, validation, verification, release to production, quality control, quality assurance, and complaint/risk management has been time consuming and a revenue drain, utilizing thousands of resource dollars and resource time. A real-time feedback loop for risk mitigation and continuous improvement, based on complaints or errors has not always been possible across the comprehensive and complete system, due to the massive number of records involved, limited resources, and delays in the timing of detecting issues, reporting issues, triaging issues, coding issues, escalating issues, and ensuring management awareness and oversight. Companies had multi-year delays in detecting product issues and ensuring timely recalls and prevention of expensive product liability lawsuits which may have been prevented with stronger, better, more accurate, comprehensive and real-time detection, trending, and reporting. The inherent variability in human judgment, experience, and the subjective interpretation of issues contribute to discrepancies in problem identification, documentation, trending, and reporting. To date, the use of computerized methods to review quality records has been primarily limited to record sorting and filing. With the advent of Large Language Model's (LLM) and Neural Networks (NN), the capability a rapid comprehensive review of all quality records exists. However, from our internal testing existing commercial large language models (from Open AI or Anthropic) are only ˜20-40% accurate at assessing quality record compliance. Moreover, large language models are prone to generating false positives by flagging issues that fall outside the scope of what a seasoned auditor would deem a genuine regulatory and quality compliance concern and/or a safety issue signal. While computerized methods have been employed in record sorting and filing, the advent of Large Language Models (LLMs) and Neural Networks (NNs) has opened up new possibilities for rapid and comprehensive quality record review. Moreover, Large language models tend to overstep their knowledge base and cite issues that human expert auditors would not consider true regulatory and quality compliance and safety and complaint concerns.

The need, therefore, exists for a novel computer-implemented method for automated quality records review and analysis.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a system diagram illustrating the creation of the expert system for automated quality record review, in accordance with an embodiment of the invention.

FIG. 2 is a flowchart of an exemplary method for employing the proprietary rules and logic in conjunction with the LLM to evaluate quality records, in accordance with an embodiment of the invention.

FIG. 3 is a more detailed flowchart expanding on the method of FIG. 2 for employing the proprietary rules and logic in conjunction with the LLM to evaluate quality records, in accordance with an embodiment of the invention.

FIG. 4 is a flowchart providing further details on the analysis of audit results from FIG. 3, in accordance with an embodiment of the invention.

FIG. 5 is a continuation of the flowchart from FIG. 4, illustrating the calculation of the final severity of audit findings, in accordance with an embodiment of the invention.

FIG. 6 is an example of a hand-written page from a quality document.

FIG. 7 is an example of processing the hand-written page of FIG. 6 with an optical character recognition technique or an NLP technique.

FIG. 8 is an example of the details of data extraction from the hand-written page of FIG. 6.

FIG. 9 is an example of the result of the conversion of a hand-written document into a machine-readable text.

### SUMMARY

An object of the present invention is to address the limitations of the prior art and provide for a novel computer-based method of automated quality records review and processing.

A further object of the invention is to provide a novel computer-based method of automated quality records review that can significantly expedite the processing of the documents as compared with traditional methods.

Another object of the invention is to provide a novel computer-based method of automated quality records review that can facilitate rapid processing of a large volume of documents, far exceeding what can be processed using traditional methods. The present invention addresses the limitations of the prior art by incorporating several key novel methods that enable large language models to detect quality issues with higher accuracy, across all available records, in real-time, and can include historic records or audits. First, novel iterative training methods are employed to provide the large language model with the nuanced understanding necessary to identify and evaluate complex logical sequences typically handled by seasoned auditors. Second, the training equips the large language model with the ability to scrutinize and cross-reference interconnected records, including those across historic timelines, to perform root cause analysis. Third, the invention implements a continuous and instantaneous review process for quality records. Fourth, to prevent the large language model from overstepping the analytical boundaries observed by human experts, strict guardrails are established during the training process. Fifth, the invention incorporates proprietary guidelines, as AI-enabled large language models generally have access to published federal and international regulations but may not have access to regulatory guidelines such as ISO standards without licensure. Finally, the invention enforces homogenized criteria for reporting thresholds, ensuring consistent and impartial results across diverse quality assessments.

### DETAILED DESCRIPTION

The following description sets forth various examples along with specific details to provide a thorough understanding of claimed subject matter. It will be understood by those skilled in the art, however, that claimed subject matter may be practiced without one or more of the specific details disclosed herein. Further, in some circumstances, well-known methods, procedures, systems, components and/or circuits have not been described in detail in order to avoid unnecessarily obscuring claimed subject matter. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

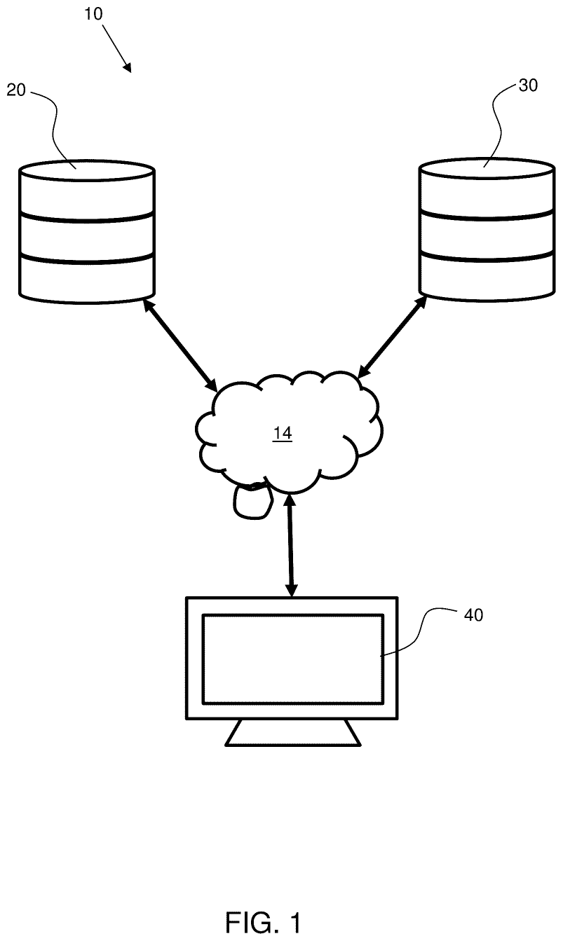

Referring now to FIG. 1, there is shown a system diagram illustrating the creation of the expert system for automated quality record review, in accordance with an embodiment of the invention. The system diagram in FIG. 1 illustrates the flow of data from the collected regulations and requirements 10 and test records to the expert system 20, private database 30, and user interface 40. The system accommodates various data storage options, including cloud-based and on-premises solutions, and enables users to interact with the data through multiple pathways and devices. By providing a comprehensive and user-friendly interface, the system empowers quality compliance experts and quality assurance personnel to effectively test, refine, and maintain the quality review rules and logic, ultimately enhancing the accuracy and efficiency of the automated quality record review process.

The process begins with the collection of regulations and requirements 10 from regulatory documents, standards, or internal procedures. Examples of regulations may include FDA regulations including but not limited to 21 CFR Parts 11, 50, 54, 312, 313, 812, 814, and/or 820, international standards ISO14155, ISO13485, ISO9001, ICH GCP, and/or a company's internal Policies or Standard Operating Procedures (SOPs).

The collected regulations and requirements 10 can be stored in various formats and locations, depending on their source and the organization's document management and retention practices. They may reside in local files, databases, document management systems, local network drives, personal computers/desktops, and/or cloud-based storage platforms. The system is designed to accommodate different data storage and retention options and can interface with these repositories through appropriate connectors and APIs.

To facilitate the creation of the expert system 20, the collected regulations and requirements 10 need to be accessible to both the human regulatory, quality and/or safety and compliance experts and the LLM. This can be achieved through several pathways. One approach is to store the regulations and requirements in a secure, controlled authorized access, centralized cloud-based platform, such as Amazon Web Services (AWS), Microsoft Azure, or Google Cloud Platform (GCP). These platforms provide secure and scalable storage solutions, allowing the regulations and requirements to be easily accessed and processed by the expert system components.

Alternatively, the regulations and the company-specific requirements can be stored on-premises within the organization's own document repositories and systems. In this case, the expert system 20 can be deployed locally, and the LLM can access the regulations and requirements through internal network connections. This approach may be preferred by organizations with strict data security and privacy requirements or those operating in regulated industries with specific data and document hosting requirements.

Regardless of the storage location, the human regulatory, quality and safety compliance experts and the LLM collaborate to create the expert system 20. The experts can access the regulations and requirements through user interfaces, such as secure, controlled, authorized access web-based portals or desktop applications, which provide intuitive navigation and search capabilities. They can review, annotate, and provide feedback on the regulations and requirements directly within these interfaces, facilitating the knowledge transfer process.

The LLM, being a machine learning model, requires the regulations and requirements to be provided in a format suitable for processing. This typically involves converting the regulations and requirements into a structured or semi-structured format, such as XML, JSON, or plain text. The data preprocessing step may include tasks like text extraction, formatting, and normalization to ensure the regulations and requirements are in a consistent and machine-readable format.

Once the expert system 20 has been trained and the quality review rules and logic (QRL) have been generated, they may be stored in a private database 30. This database serves as a central repository for the proprietary knowledge base, making it accessible to the automated quality record review process.

The private database 30 can be hosted on-premises or in the cloud, depending on the organization's infrastructure and security requirements. Cloud-based database solutions, such as AWS RDS, Azure SQL Database, or Google Cloud SQL, offer scalability, reliability, and built-in security features. They allow for easy integration with other cloud-based components of the expert system.

If the organization prefers to keep the database on-premises, they can use traditional database management systems like Oracle, Microsoft SQL Server, or MySQL. In this case, the expert system components, including the LLM and the quality record review application, would need to establish secure connections to the on-premises database.

The final step shown in FIG. 1 is the testing and refinement of the quality review rules and logic 40. This step involves analyzing the content of electronic test records using natural language processing and other techniques like optical character recognition for scanned documents. The test records can be stored in various formats and locations, similar to the collected regulations and requirements 10.

To facilitate the testing process, the test records need to be accessible to the expert system components. If the records are stored in cloud-based storage, the testing module can directly access them through appropriate APIs or connectors. If the records are stored on-premises, the testing module may need to establish secure connections to the local storage systems.

The extracted information from the test records may be compared to the QRL stored in the private database 30. The testing module retrieves the relevant rules and logic from the database and applies them to the test records. The results of this comparison may be used to assess the effectiveness of the QRL and identify areas for improvement.

The user, typically a regulatory, quality assurance, or safety compliance expert, may interact with the testing and refinement process through a user interface 40. This interface can be accessed through various devices, such as computers, tablets, or smartphones, depending on the user's preferences and the system's compatibility.

The user interface may provide a comprehensive view of the testing results, including the test records analyzed, the rules and logic applied, the identified compliance issues. The user can review these results, provide feedback, and make necessary adjustments to the QRL through the interface.

The interface may offer features like data visualization, dashboards, and reporting capabilities to facilitate the interpretation and analysis of the testing results. Users can filter and sort the results based on different criteria, such as record type, regulatory requirement, type of quality issue identified, or risk severity of compliance issues. They can also drill down into specific records or rules requirements for detailed examination.

If the user identifies areas for improvement or refinement in the QRL, they can make the necessary changes directly through the user interface. This may involve modifying existing rules, adding new criteria, or adjusting thresholds. The updated QRL is then saved back to the private database 30, ensuring that the changes are persisted and reflected in future quality record reviews.

Throughout the testing and refinement process, the user interface enables collaboration and communication among the regulatory experts and quality assurance team members. Users can share their findings, discuss potential improvements, and document their decisions within the interface. This collaborative approach helps in building consensus, ensuring consistency, and maintaining a comprehensive audit trail of the refinement process.

In addition to the desktop or web-based user interface, the system may also provide mobile access through dedicated applications or responsive web designs. This allows users to access the testing results and perform refinements on the go, using their tablets or smartphones. Mobile access is particularly useful for field-based quality assurance personnel who may need to review and update the QRL while conducting on-site inspections or audits.

The user interface 40 serves as the primary point of interaction between the users and the expert system. It provides a user-friendly and intuitive means to review the testing results, refine the QRL, and monitor and measure the overall performance of the automated quality record review process.

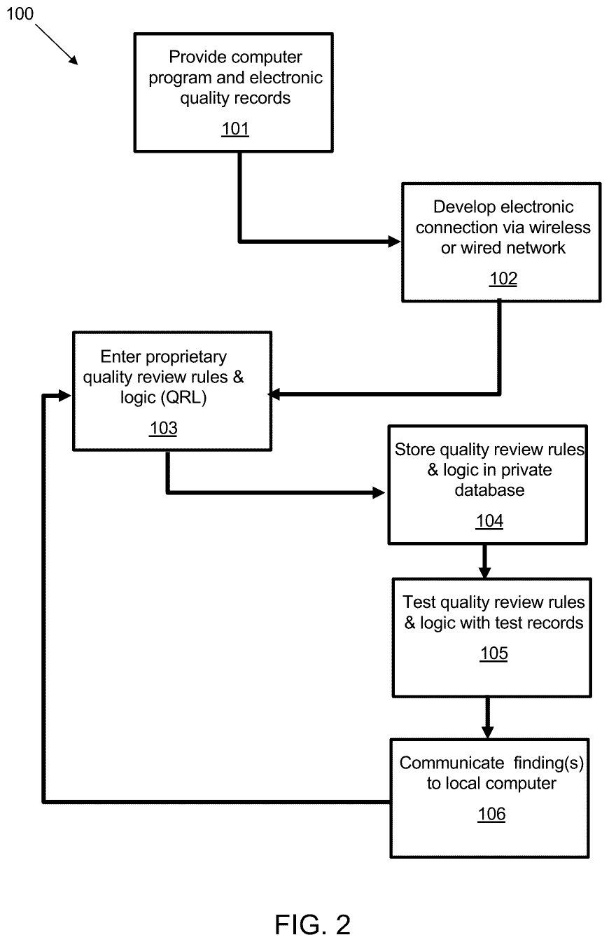

Referring now to FIG. 2, there is shown a flowchart of an exemplary method for employing the proprietary rules and logic in conjunction with the LLM to evaluate quality records, in accordance with an embodiment of the invention. The method begins by providing a computer program and electronic quality records 100. This system serves as the foundation for the automated quality record review process and consists of several key components.

The computer program may be designed to orchestrate the various steps of the quality record review process, from data ingestion and analysis to reporting and trend generation. It is developed using modern programming languages and frameworks, such as Python, Java, or .NET, and follows best practices for software development, including modular design, version control, and automated testing.

The electronic proprietary system 100 encompasses the hardware and software infrastructure required to support the automated review process. This may include servers, storage systems, databases, and networking components. The system is designed to be scalable, reliable, and secure, capable of handling large volumes of quality records and ensuring the integrity and confidentiality of the data in them.

The next step is developing an electronic connection via a wireless or wired network 101. This connection enables communication between the various components of the system, including the local computer where the quality and compliance findings will be viewed. The network can be established using various technologies, depending on the organization's infrastructure and requirements.

For wireless connectivity, the system may utilize Wi-Fi, cellular networks (e.g., 4G or 5G), or satellite communications. These wireless options provide flexibility and mobility, allowing users to access the system remotely using laptops, tablets, or smartphones. Wireless connections are encrypted and secured using industry-standard protocols, such as WPA2 or VPN, to protect the confidentiality and integrity of the data transmitted over the network.

Wired connectivity options include Ethernet, fiber optic, or other cable-based technologies. Wired connections offer higher bandwidth, lower latency, and greater stability compared to wireless options. They are suitable for connecting fixed workstations, servers, and other stationary devices within the organization's premises. Wired networks can be segmented and secured using firewalls, access controls, and other network security measures.

Once the system and network are in place, the proprietary quality rules and logic (QRL) are entered into the system 102. These rules and logic are the result of the expert system training process described in FIG. 1, where human regulatory, quality, and safety compliance experts and AI LLM generate novel advanced rules for evaluating quality records.

The QRL can be entered into the system through various methods, depending on their format and the system's input capabilities. One approach is to provide a user interface where regulatory, quality, safety and compliance experts can manually input the rules and logic using a structured format, such as a rule editor or a decision tree builder. This allows for the direct entry of complex rules and conditions, along with associated actions and outcomes.

Another method is to import the QRL from external sources, such as spreadsheets, XML files, or JSON documents. This enables the bulk loading of rules and logic that have been previously defined and validated outside the system. The system should have the capability to parse and interpret these external formats, mapping them to the internal representation used by the quality review engine.

In addition to manual input and file imports, the system may also provide an API or a web service interface for programmatic entry of the QRL. This allows for the integration of the quality review system with other software tools and platforms, enabling the automated exchange of rules and logic between systems.

Regardless of the input method, the QRL undergoes a validation and verification process to ensure their consistency, completeness, correctness, and compliance to pre-determined specifications. This may involve syntax checking, logical validation, and cross-referencing against existing rules and standards. Any errors or inconsistencies detected during this process are reported to the user for correction before the QRL is finalized and stored.

After entry, the quality review rules and logic are securely stored in a private database 103. This database serves as the central repository for the proprietary knowledge base that will be used in the record evaluation process. The database is designed to provide efficient storage, retrieval, and querying of the QRL, enabling fast and scalable access during the automated review process.

The database can be implemented using various technologies, such as relational databases (e.g., MySQL, PostgreSQL, Oracle), NoSQL databases (e.g., MongoDB, Cassandra), or graph databases (e.g., Neo4j, Amazon Neptune), depending on the specific requirements and characteristics of the QRL. The choice of database technology depends on factors such as the volume and complexity of the rules, the expected query patterns, and the scalability and performance needs of the system.

To ensure the security and integrity of the QRL, the database is protected using access control mechanisms, such as user authentication, role-based access control, and data encryption. Only authorized users, such as regulatory, quality, and safety compliance experts and system administrators, are granted access to the database, and their actions are logged and audited for traceability and accountability.

The database also includes backup and recovery mechanisms to protect against data loss or corruption. Backups are performed, and disaster recovery and business continuity procedures are established to ensure the availability and continuity of the QRL in case of system failures or other disruptions.

To ensure the effectiveness of the QRL, it is tested using a set of test records 104. This validation process allows for identification of any needed updates to ensure any necessary refinements are be made before deploying the rules and logic for actual use. The testing process involves several steps to thoroughly evaluate, validate, and verify the QRL against a representative sample of quality records.

First, a set of test records may be selected that covers a wide range of scenarios and edge cases. These records are carefully chosen to include both compliant and non-compliant examples, as well as records with varying levels of complexity and ambiguity. The test records are sourced from historical data, simulated data, or artificially generated data that mimics real-world quality records.

Next, the test records may be processed by the automated review system using the QRL. The system may apply the rules and logic to each record, evaluating their compliance against the defined criteria. The results of the evaluation, including any identified issues or non-conformances, are recorded and stored for further analysis.

The testing process may also include a manual review of the automated results by human compliance experts. This step involves comparing the system's findings with the expected outcomes based on the known compliance status of the test records and human understanding of regulations, requirements, and compliance methodology. Any discrepancies or false positives/negatives are carefully examined to identify potential issues with the QRL or the review process.

Based on the testing results, the QRL may undergo iterative refinements to improve their accuracy, coverage, and specificity. This may involve modifying existing rules, adding new rules, or adjusting the thresholds and parameters used in the evaluation process. The refinements are made in collaboration with the regulatory experts and are guided by the insights gained from the testing process.

The testing and refinement cycle continues until the QRL achieve a satisfactory level of performance, as measured by suitable metrics, for example, such as precision, recall, and F1 score (a metric that measures the performance of a machine learning model by balancing precision and recall). These metrics provide quantitative measures of the system's ability to correctly identify compliant and non-compliant records while minimizing false positives and false negatives.

Before deploying the QRL to the production environment, a final round of testing is performed in a staging or pre-production environment. This allows for the verification of the deployment process and the compatibility of the QRL with the target systems. Any issues identified during this stage are addressed before proceeding with the production deployment.

Once the QRL have been thoroughly tested and validated, they are deployed to the production environment for use in the actual quality record review process. The deployment process involves packaging the QRL and associated configurations into a format that can be easily distributed and installed on the target systems. This may involve creating installation scripts, containerizing the QRL components, or integrating them into existing software deployment pipelines.

Finally, the system generates a comprehensive quality review report 210 detailing the findings of the automated evaluation process. This report serves as a centralized and authoritative record of the quality compliance assessment, providing a clear and concise summary of the review results.

The quality review report is automatically generated by the system, leveraging the data and insights gathered throughout the review process. It consolidates the information from the classification results, issue descriptions, and any additional analyses or metrics derived from the reviewed records.

The report starts with an executive summary that highlights the key findings and overall compliance status of the reviewed records. This summary provides a high-level overview of the number of records reviewed, the percentage of acceptable and not acceptable records, and any significant trends or patterns identified during the review.

The report then proceeds to provide a detailed breakdown of the review results, organized by various dimensions such as record type, quality issue category, severity level, or regulatory and compliance requirements topic. This granular analysis allows stakeholders to quickly identify the areas of strength and weakness in the quality records and the overall health of the quality system.

For each dimension, the report presents clear, user-friendly, focused and visually appealing charts, graphs, and tables that illustrate the distribution of quality issues, compliance scores, and other relevant metrics. These visualizations help in communicating complex data in an easily understandable format, facilitating efficient, comprehensive, data-driven, risk-based decision-making and prioritization.

The report also includes a section dedicated to the detailed descriptions of the identified quality compliance issues. This section provides a comprehensive list of all nonacceptable records, along with their associated issue descriptions, contextual information, and any relevant references or links. The descriptions are organized in a structured and easily navigable format, allowing stakeholders to drill down into specific issues and understand their root causes and potential impact.

In addition to the issue descriptions, the report may also include recommendations or suggested corrective actions for each identified problem. These recommendations are based on the QRL, industry best practices, and the expertise of the regulatory and quality compliance team. They provide guidance on the steps that can be taken to assist in addressing and corrective the issues, work to minimize their recurrence and improve overall quality and compliance.

The report also incorporates a section on data quality and completeness, highlighting any gaps, inconsistencies, or limitations in the reviewed records. This section helps in identifying areas where data and document collection or management processes need improvement, promoting the improved reliability and integrity of future quality assessments.

The quality review report is designed to be easily shareable and accessible to all relevant stakeholders. It can be generated in various formats, such as PDF, HTML, or interactive dashboards, depending on the organization's preferences and distribution channels. The report is securely stored in the system's repository, with appropriate, authorized access controls and version management to ensure the integrity, security, and confidentiality of the information.

The report generation process may be automated and can be triggered on a predefined schedule or on-demand, based on the organization's quality review cycles and reporting requirements. This automation ensures that the most up-to-date and accurate information is always available to decision-makers, enabling timely and proactive quality and risk management.

The quality review report serves as a valuable communication and collaboration tool, facilitating the sharing of regulatory, quality and safety compliance insights across the organization. It provides a common language and framework for discussing regulatory, quality, and safety compliance issues aligning stakeholders around improvement priorities, and tracking progress over time.

The report also forms the basis for further analysis and action planning. Quality management teams can use the report to identify systemic issues, use comprehensive reports to more precisely identify potential root causes and scope of issues, prioritize corrective actions, and allocate resources effectively. The report's findings can be integrated into the organization's continuous improvement processes, driving targeted initiatives and measuring the effectiveness of quality interventions.

This report, along with the individual record and issue classifications, may then be communicated to a local computer 106 for viewing and further action by quality control and quality assurance personnel and/or management.

The communication process involves securely transmitting the quality review report and its associated data to the designated local computer or system. This transmission can occur through various methods, such as email, file transfer protocols (FTP), or secure web-based interfaces, depending on the organization's IT infrastructure and security policies.

The local computer 106 may serve as the primary access point for quality control and quality assurance personnel to view and interact with the review results. It provides a user-friendly interface that allows users to easily navigate through the report, drill down into specific sections or records, and perform advanced searches or filters based on various criteria.

The interface may include interactive features, such as clickable charts, expandable tables, or hyperlinked references, enabling users to explore the data in more depth and access additional contextual information. These features enhance the usability and interpretability of the review results, facilitating effective analysis and decision-making.

Quality control and quality assurance personnel and management can use the local computer to review the overall compliance status, identify areas of concern, and prioritize corrective actions based on the severity and impact of the identified issues. They can access the detailed descriptions of each not acceptable record, gaining a comprehensive understanding of the nature, scope and frequency of the quality issues.

The local computer also serves as a collaboration platform, allowing multiple quality control and quality assurance personnel to access and contribute to the review results simultaneously. Users can add their own comments, annotations, or suggested actions directly within the interface, fostering a shared understanding and facilitating coordinated problem-solving efforts.

The local computer may also provide a centralized repository for storing and organizing historical quality review reports and related documentation. This allows for easy retrieval and comparison of past review results, enabling trend analysis, performance tracking, and continuous improvement over time.

To ensure the security and confidentiality of the quality review data, the local computer may implement robust access control mechanisms. Only authorized personnel with the appropriate credentials and permissions can access the review results and associated information. The system includes audit trails and logging features to track user actions and maintain accountability.

The communication of the quality review report to the local computer marks the culmination of the automated quality record review process. It provides quality assurance personnel and management with a comprehensive and actionable view of the compliance status, enabling them to make informed decisions and drive effective quality improvement initiatives.

By leveraging the power of automation, the system ensures that quality assurance personnel have timely and accurate information at their fingertips, reducing the manual effort and time required for quality record review. This enables organizations to allocate their resources more efficiently, focusing on high-value activities such as timely identification of issues across the system rather than a sample of records, a detailed and precise root cause analysis and scope based on comprehensive records review, corrective action implementation, and proactive quality management monitoring, measurement and oversight.

Overall, the communication of the quality review report to the local computer is a critical step in the automated quality record review process. It empowers quality assurance personnel and management with the insights and tools they need to identify, prioritize, and address quality issues, ultimately leading to improved compliance, reduced risk, reduced cost, improved safety and compliance metrics, and enhanced overall quality performance.

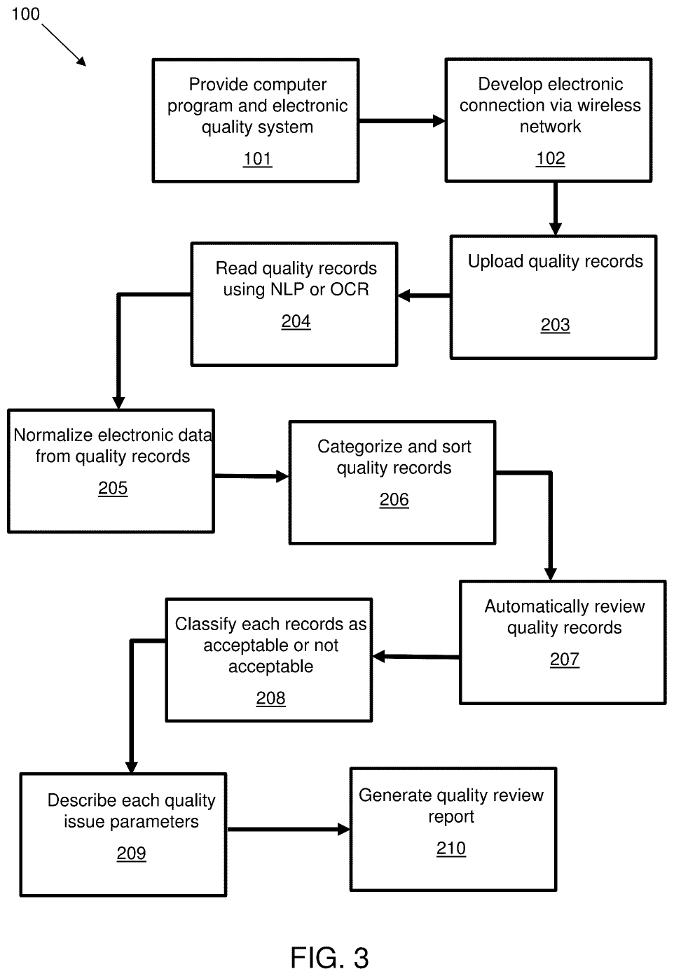

Referring now to FIG. 3, there is shown a more detailed flowchart expanding on the method of FIG. 2 for employing the proprietary rules and logic in conjunction with the LLM to evaluate quality records, in accordance with an embodiment of the invention. The method begins by providing a computer program and electronic quality records 100 and developing an electronic connection via a wireless network 101, as described in FIG. 2.

The computer program and electronic quality record storage system 100 form the backbone of the automated quality record review process. The computer program is responsible for orchestrating the various steps involved in the process, from data ingestion to analysis and reporting. It is developed using robust programming languages and frameworks, such as Python, Java, or C#, and adheres to industry best practices for software development, including modular design, version control, and automated testing.

The electronic quality record storage system 100 comprises the necessary hardware and software components to support the automated review process. This includes servers, storage systems, databases, and networking infrastructure. The system is designed to be scalable, fault-tolerant, and secure, ensuring the integrity and confidentiality of the quality records throughout the review process.

Developing an electronic connection via a wireless network 101 is crucial for enabling seamless communication between the various components of the system. The wireless network can be established using different technologies, depending on the organization's infrastructure and requirements.

The next step in the process is uploading the quality records 203 to be evaluated. The system supports various methods for uploading records, catering to different user preferences and data formats.

One common approach is to provide a web-based user interface where users can manually upload individual records or batches of records. The interface should be intuitive and user-friendly, allowing users to easily select and upload files from their local machines or network drives. The system should support a wide range of file formats, such as PDF, Word documents, Excel spreadsheets, and plain text files.

To streamline the upload process, the system may offer drag-and-drop functionality, enabling users to simply drag the desired files from their local machines onto the web interface. Progress indicators and real-time feedback should be provided to keep users informed about the upload status and any potential errors or issues.

In addition to manual uploads, the system should support automated data ingestion methods. This can be achieved through integration with existing document management systems, file servers, or cloud storage platforms. The system can leverage APIs or data connectors to automatically retrieve quality records from these sources on a scheduled or triggered basis.

For example, the system can integrate with quality record storage system such as Mastercontrol or SAP or a Document Management System like SharePoint or a Trial Master File system like Veeva, periodically scanning designated folders or libraries for new or updated quality records. Whenever a new record is detected, the system automatically downloads and processes it without requiring manual intervention.

Once the quality records are successfully uploaded, they may be stored in a secure and scalable storage system. This can be a centralized database, a distributed file system, or a combination of both, depending on the volume and characteristics of the records. The storage system should provide high availability, fault tolerance, and data redundancy to ensure the integrity and accessibility of the records.

Access control mechanisms, such as role-based access control (RBAC) or attribute-based access control (ABAC), are enforced to ensure that only authorized users can access and manipulate the stored records. Audit trails and logging mechanisms are also implemented to track user actions and maintain accountability.

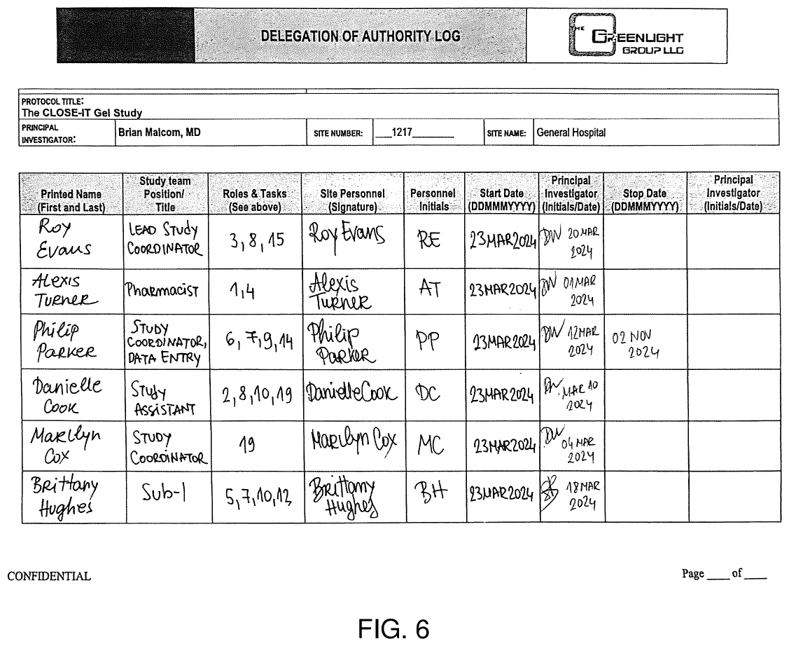

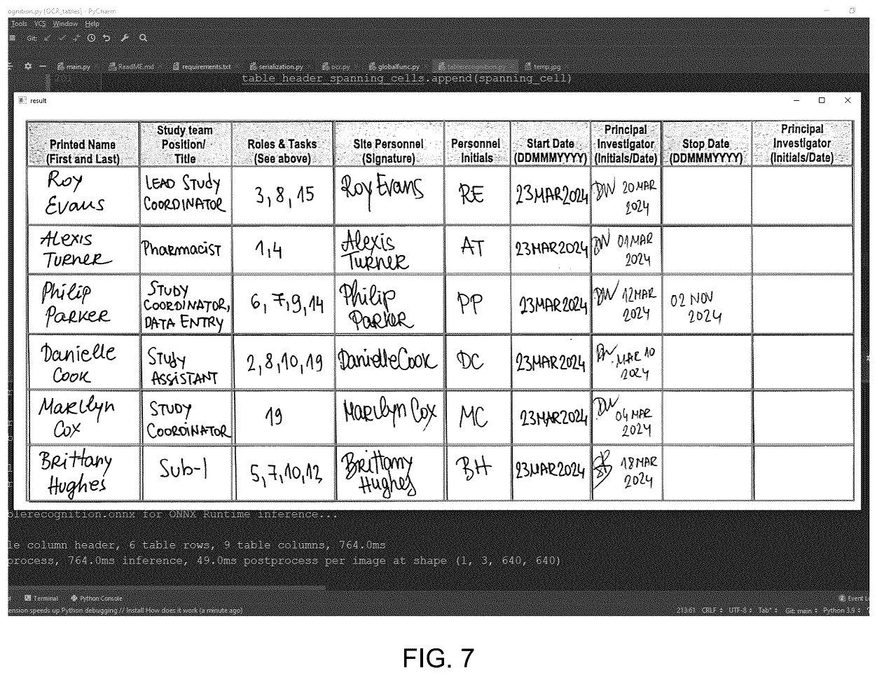

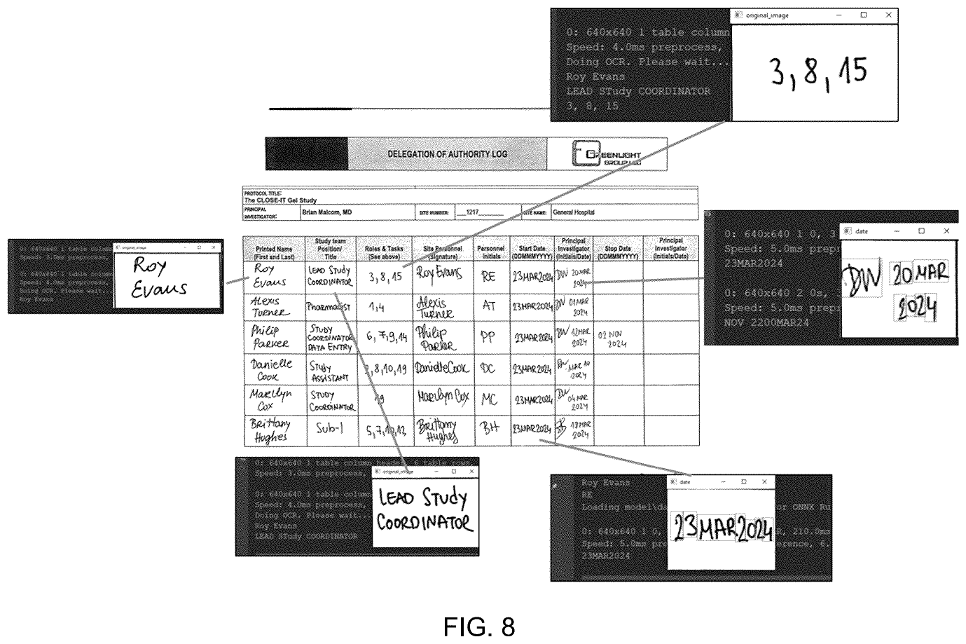

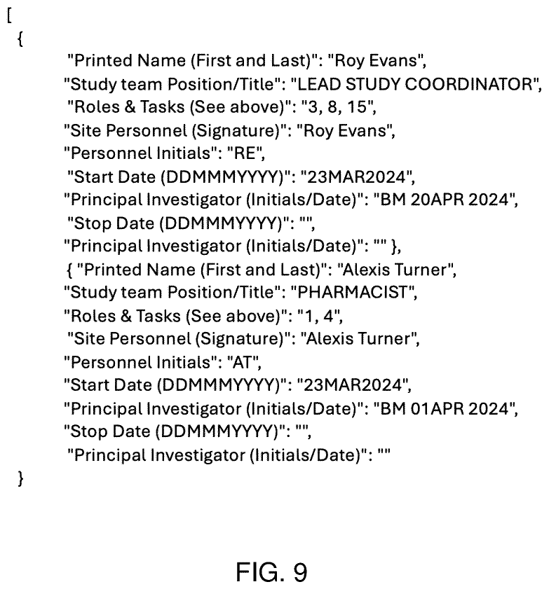

After the records are uploaded and stored, they may be read using natural language processing (NLP) or optical character recognition (OCR) 204, depending on their format, to extract the text and data. This step is critical for converting the unstructured or semi-structured information contained in the quality records into a machine-readable format that can be processed by the system. Examples of various stages of such processing are seen in FIGS. 6-9.

For records in digital text formats, such as PDF, Word documents, or plain text files, NLP techniques may be employed to extract the relevant information. NLP libraries and frameworks, such as spaCy, NLTK, or Stanford CoreNLP, are used to tokenize the text, identify named entities, and extract key phrases and concepts. The NLP process may involve several substeps, such as:

Text preprocessing: This step involves cleaning and normalizing the text data by removing noise, such as special characters, formatting tags, or irrelevant information. It may also include converting the text to lowercase, removing stop words (common words like “the” or “and”), and stemming or lemmatizing words to their base or dictionary form.

Named entity recognition (NER): NER is used to identify and extract named entities, such as person names, organizations, locations, dates, or measurements, from the text. This helps in structuring the data and identifying key information elements within the quality records.

Part-of-speech (POS) tagging: POS tagging involves assigning grammatical tags (e.g., noun, verb, adjective) to each word in the text. This information can be used to understand the context and relationships between words, aiding in the extraction of meaningful information.

Dependency parsing: Dependency parsing analyzes the grammatical structure of sentences, identifying the relationships between words and phrases. This helps in understanding the context and extracting complex information, such as cause-effect relationships or conditional statements, from the quality records.

Coreference resolution: Coreference resolution involves identifying and linking multiple mentions of the same entity within the text. This helps in resolving ambiguities and ensuring consistent interpretation of the extracted information.

For records in image or scanned formats, OCR techniques may be used to convert the visual information into machine-readable text. For basic text in images, OCR engines within the LLM are employed to recognize and extract text from images. For specialized text like checkboxes or handwriting within tables, specialized proprietary OCR tools are employed. The OCR process typically involves the following sub steps:

Image preprocessing: This step involves enhancing the quality of the scanned images to improve the accuracy of text recognition. Techniques like noise reduction, skew correction, and binarization are applied to optimize the images for OCR.

Layout analysis: Layout analysis is performed to identify and segment the different regions within the scanned document, such as text blocks, tables, or images. This helps in extracting the relevant information while preserving the structure and context of the document.

Character recognition: The OCR engine analyzes the preprocessed image and recognizes individual characters and words. This process may involve using machine learning models trained on large datasets of handwritten and printed text samples.

Post-processing: After the text is recognized, post-processing techniques are applied to improve the accuracy and readability of the extracted text. This may include spell checking, grammar correction, and formatting adjustments to ensure the extracted text is consistent and usable.

The extracted text and data from the quality records are then stored in a structured format, such as JSON or XML, along with metadata information like the source document, extraction timestamp, and any associated tags or categories. This structured data is ready for further processing and analysis in the subsequent steps of the quality record review process.

Throughout the text extraction process, error handling and exception management mechanisms may be implemented to gracefully handle any issues or failures that may occur. This includes handling scenarios like corrupted or password-protected files, low-quality scans, or unsupported file formats. Detailed logging and error reporting mechanisms are in place to assist in troubleshooting and maintaining the reliability of the extraction process.

The extracted data from the quality records may then be normalized into a standardized format 205 by converting unstructured information into structured data types and structures. This step is crucial for enabling effective analysis and comparison of the quality records across different sources and formats.

Data normalization involves transforming the extracted information into a consistent and standardized representation. This process ensures that similar data elements are represented uniformly, making it easier to perform queries, aggregations, and analytics on the quality records.

The normalization process typically involves several sub-steps, such as:

Data cleaning: This step involves removing any irrelevant or redundant information from the extracted data. It may include removing special characters, whitespace, or formatting artifacts that do not contribute to the content analysis. Data cleaning ensures that the normalized data is free from noise and inconsistencies.

Data type conversion: The extracted data is converted into appropriate data types based on the nature of the information. For example, numeric values are converted to integers or floating-point numbers, dates are converted to a standardized date format (e.g., ISO 8601), and categorical data is mapped to predefined categories or labels. This step ensures that the data is in a format suitable for analysis and computation.

Data structuring: The normalized data is organized into a structured format, such as a relational database schema or a hierarchical JSON structure. This involves defining the appropriate tables, fields, and relationships to represent the quality record information. The structured format enables efficient querying, filtering, and aggregation of the data.

Data validation: The normalized data undergoes validation checks to ensure its integrity and consistency. This may include verifying that required fields are present, checking for data type mismatches, and validating the data against predefined rules or constraints. Data validation helps in identifying and handling any anomalies or errors in the extracted information.

Data enrichment: In some cases, the normalized data may be enriched with additional information from external sources or derived based on predefined rules. For example, if a quality record mentions a specific product or component, the system may automatically retrieve relevant information from a product database and append it to the normalized data. Data enrichment enhances the context and usefulness of the quality record information.

The normalization process may involve the use of various data transformation and mapping techniques, such as regular expressions, lookup tables, or machine learning models. These techniques help in identifying patterns, extracting relevant information, and mapping it to the standardized format.

For example, a regular expression can be used to extract specific data elements, such as measurements or part numbers, from unstructured text. Lookup tables can be employed to map domain-specific terminology or abbreviations to their standardized equivalents. Machine learning models, such as named entity recognition or text classification, can assist in automatically categorizing or tagging the quality record information based on predefined taxonomies or ontologies.

The normalized data may be stored in a centralized repository, such as a relational database or a NoSQL database, depending on the nature and volume of the data. The database schema is designed to accommodate the standardized data model and enable efficient querying and analysis.

To ensure data consistency and accuracy, the normalization process may include data governance mechanisms, such as data quality checks, data lineage tracking, and version control. These mechanisms may help in maintaining the integrity and reliability of the normalized data over time.

The normalized data serves as the foundation for the subsequent steps in the quality record review process, such as categorization, sorting, and automated compliance analysis. By standardizing the data into a consistent format, the system can perform meaningful comparisons, aggregations, and analytics across different quality records, enabling a comprehensive and accurate assessment of compliance and quality issues.

Throughout the normalization process, performance optimization techniques are applied to handle large volumes of data efficiently. This may include techniques like parallel processing, data partitioning, or distributed computing to scale the normalization process and ensure timely completion.

Error handling and logging mechanisms are implemented to capture and resolve any issues that may arise during the normalization process. Detailed logs and error reports are generated to assist in troubleshooting and monitoring the normalization pipeline.

After normalization, the quality records may be categorized and sorted in step 206. This step involves mapping the standardized record information to related categories in the proprietary knowledge base, associating the record content with the relevant QRL (Quality Rules & Logic).

Categorization is a critical step in organizing and contextualizing the quality records based on their subject matter, type, or relevant characteristics. It enables the system to apply the appropriate QRL and perform targeted analysis based on the specific requirements and guidelines associated with each category.

The categorization process typically involves a combination of rule-based and machine learning techniques. The system leverages the proprietary knowledge base, which contains predefined categories, keywords, and mapping rules, to automatically assign quality records to the relevant categories.

The knowledge base may be built and maintained by domain experts who have a deep understanding of the quality requirements, regulations, and standards specific to the organization or industry. These experts define the category taxonomy, develop the mapping rules, and continuously update the knowledge base to ensure its relevance and accuracy.

The categorization process may start by analyzing the normalized data of each quality record and extracting key information elements, such as keywords, phrases, or semantic concepts. These elements are then matched against the predefined categories and mapping rules in the knowledge base.

For example, if a quality record contains keywords like “safety incident” or “workplace injury,” the system may automatically categorize it under the “Safety and Health” category. Similarly, if a record mentions specific regulatory standards, such as “ISO 9001” or “FDA 21 CFR Part 11,” it may be classified under the relevant compliance categories.

The categorization process may involve multiple levels of granularity, allowing for a hierarchical structure of categories and subcategories. This enables a more precise and nuanced classification of quality records based on their specific characteristics or requirements.

In addition to rule-based categorization, machine learning techniques, such as text classification or clustering, can be employed to automatically discover patterns and group similar quality records together. These techniques learn from historical data and can adapt to new or evolving categories over time.

The machine learning models may be trained on a labeled dataset, where quality records are manually categorized by domain experts. The models learn the underlying patterns and features that distinguish different categories and can then predict the appropriate category for new or unseen records.

To ensure the accuracy and consistency of the categorization process, the system incorporates feedback loops and manual review mechanisms. Domain experts can review and validate the automatically assigned categories, providing feedback to refine the categorization rules and improve the machine learning models.

Once the quality records are categorized, they are sorted based on predefined criteria or user-specified preferences. Sorting allows for a logical and structured presentation of the records, enabling users to quickly locate and review relevant information.

The sorting criteria can vary depending on the specific requirements and use cases. Common sorting options include:

Date: Records can be sorted chronologically based on their creation date, modification date, or any other relevant date field. This allows users to review records in a time-ordered manner and identify trends or patterns over time.

Severity or priority: Records can be sorted based on the severity or priority of the associated quality issues. This enables users to focus on the most critical or high-impact records first, ensuring that urgent matters are addressed promptly.

Category: Records can be sorted based on their assigned categories, allowing users to review records pertaining to specific subject areas or compliance requirements.

Source or department: Records can be sorted based on their originating source, such as the department, team, or individual responsible for creating or managing the record. This facilitates traceability and accountability within the organization.

Custom fields: The system may allow users to define custom sorting criteria based on specific metadata fields or attributes associated with the quality records. This provides flexibility in organizing and presenting the records based on unique business requirements.

The sorted records may be displayed in a user-friendly interface, such as a web-based dashboard or a desktop application. The interface provides intuitive navigation and filtering options, allowing users to easily browse through the records and drill down into specific details.

Visual cues, such as color-coding or iconography, may be used to highlight important information or flag records that require immediate attention. For example, records with high-severity issues may be displayed with a red indicator, while records that are overdue for review may have a clock icon next to them.

The categorization and sorting process enables efficient retrieval and review of quality records, helping users quickly identify and address potential quality issues or compliance gaps. It provides a structured and organized view of the quality data, facilitating data-driven decision-making and continuous improvement efforts.

Throughout the categorization and sorting process, data integrity and security measures are implemented to ensure the confidentiality and reliability of the quality records.

Audit trails and version control mechanisms are employed to track changes made to the categorization rules, sorting criteria, or quality records themselves. This ensures traceability and accountability, allowing for the reconstruction of historical states and the identification of any unauthorized modifications.

With the records categorized, the system automatically reviews them for compliance using the proprietary QRL in conjunction with LLM (Large Language Models) 207. This novel combination enables a level of interpretation and issue detection not possible with LLM alone.

The QRL represents the organization's accumulated knowledge and expertise in quality management, regulatory compliance, and industry best practices. It encapsulates a comprehensive set of rules, guidelines, and criteria that define the expected standards and requirements for quality records.

The QRL may be developed and maintained by a team of domain experts, including quality managers, regulatory specialists, and subject matter experts. They collaborate to define the rules, thresholds, and decision logic that govern the automated compliance review process.

The QRL may be structured in a modular and hierarchical manner, allowing for granular control over the review process. Each category or subcategory of quality records may be associated with a specific set of rules and criteria that are relevant to that particular domain.

For example, the QRL may include rules specific to safety incident reporting, such as mandatory fields, timeframes for investigation and corrective action, and required approvals. Similarly, there may be rules related to product quality control, such as acceptable tolerance levels, testing requirements, and documentation standards.

The QRL may be implemented using a combination of rule-based logic, decision trees, and machine learning models. The rule-based component allows for the explicit encoding of known compliance requirements and best practices. Decision trees provide a structured approach to evaluating complex scenarios and determining the appropriate course of action. Machine learning models, trained on historical data and expert knowledge, can identify patterns, anomalies, and potential issues that may not be captured by predefined rules alone.

During the automated compliance review process, the system applies the QRL to each categorized quality record. It analyzes the record's content, metadata, and associated data, comparing it against the relevant rules and criteria defined in the QRL.

The LLM plays a crucial role in this process by enabling the system to understand and interpret the natural language content of the quality records. Large language models are advanced AI models that have been trained on vast amounts of text data, allowing them to comprehend and generate human-like language.

The LLM may be fine-tuned specifically for the domain of quality management and regulatory compliance. It is trained on a curated dataset of quality records, regulatory documents, and industry-specific terminology. This fine-tuning process ensures that the LLM has a deep understanding of the language, concepts, and context relevant to the compliance review task.

During the review process, the LLM analyzes the text of each quality record, extracting key information, identifying relevant entities, and understanding the semantic meaning of the content. It can recognize specific terminology, acronyms, and phrases that are commonly used in the quality domain.

The LLM's language understanding capabilities enable it to interpret the nuances and intent behind the written content. It can identify potential issues, such as incomplete or ambiguous information, inconsistencies, or non-conformance to required standards.

For example, if a quality record describes a safety incident, the LLM can analyze the narrative, extracting relevant details such as the incident date, awareness date, report date, location, involved parties, involved systems, and determine root cause. It can then compare this information against the QRL to determine if all the necessary reporting requirements have been met.

The LLM trained with the QRL can also identify potential risks or areas of concern that may not be explicitly stated in the quality record. By leveraging its knowledge of language patterns and context, the LLM can flag issues that may require further investigation or attention.

The automated compliance review process powered by the combination of QRL and LLM provides several key benefits:

Consistency and objectivity: The system applies the same set of rules and criteria consistently across all quality records, reducing the potential for human error or bias. It ensures that compliance assessments are objective and based on predefined standards.

Scalability and efficiency: Automated review enables the processing of large volumes of quality records in a fraction of the time required for manual review. It allows organizations to keep pace with the growing volume and complexity of quality data while maintaining a high level of compliance oversight.

Continuous monitoring: The system can continuously monitor the flow of quality records, identifying potential issues or non-conformances in real-time. This proactive approach enables organizations to address compliance gaps promptly and prevent minor issues from escalating into major problems.

Insights and trend analysis: The automated review process generates a wealth of data and insights that can be used for trend analysis, risk assessment, and continuous improvement. The system can identify recurring patterns, systemic issues, and areas of strength or weakness in the quality management, risk management, and oversight processes.

Auditability and traceability: The system maintains a detailed audit trail of the compliance review process, including the specific rules and criteria applied, the LLM's interpretations, and the resulting assessments. This audit trail provides a transparent and verifiable record of the compliance status of each quality record.

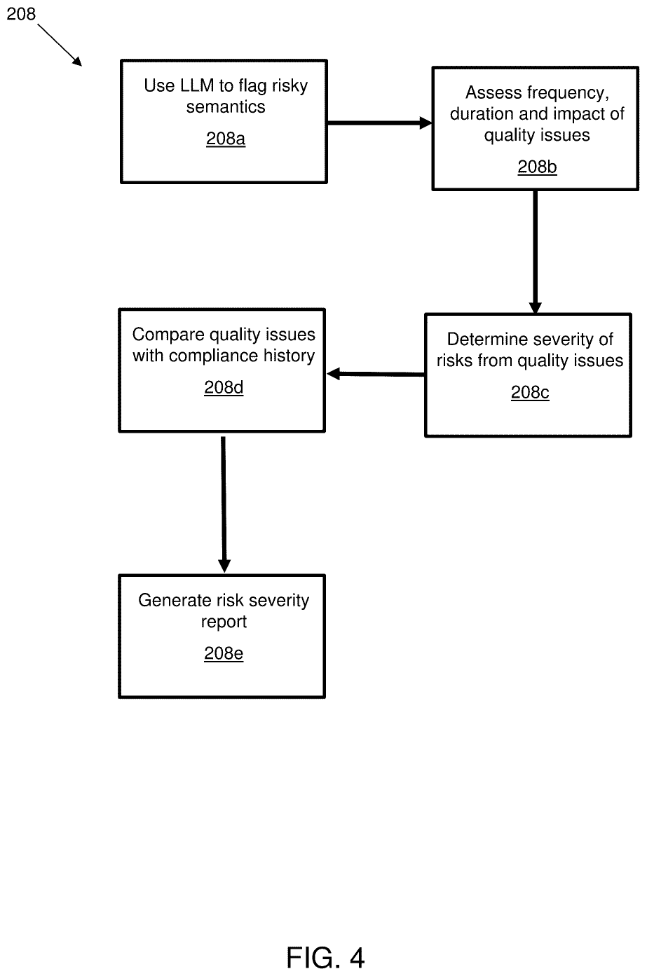

The compliance assessment report results are then analyzed in 208, which involves several sub-steps detailed in FIG. 4. This analysis phase is critical for understanding the type, frequency, and incidence implications of the compliance review results, suggesting potential root causes and scope, identifying potential risks, and providing factual data-driven information for determining the appropriate course of action.

Referring now to FIG. 4, there is shown a flowchart providing further details on the analysis of compliance assessment results from FIG. 3, in accordance with an embodiment of the invention.

The analysis process begins by using the LLM (Large Language Model) to flag risky semantics 208a. Risky semantics refer to language patterns, phrases, or terminology that may indicate potential compliance issues, safety concerns, or areas of high risk.

The LLM trained our the QRL can identify and highlight these risky semantics within the quality records. It looks for specific triggers, such as:

Language indicating non-conformance: The LLM can identify phrases or statements that suggest a deviation from required standards or procedures, such as “not following protocol,” “skipped step,” “missing required value,” or “out of specification.”

Safety-related keywords: The LLM can flag keywords or phrases related to safety incidents, hazards, or potential risks, such as “injury,” “accident,” “near miss,” “complaint,” “user error,” “malfunction,” or “unsafe condition.”

Uncertainty or ambiguity: The LLM can detect language that indicates uncertainty, lack of clarity, or incomplete information, such as “unsure,” “to be determined,” or “needs further investigation.”

Negative sentiment: The LLM can identify language expressing negative sentiment or concerns, such as “dissatisfied,” “problematic,” or “unacceptable.”

By flagging these risky semantics, the LLM draws attention to the quality records that may require further scrutiny or immediate action. It provides a focused lens through which the subsequent analysis steps can prioritize and address potential issues.

The flagged quality records are then subjected to a more detailed assessment of the type, incidence, severity, frequency, duration, and scope of the identified quality compliance issues 208b. This step involves quantifying and categorizing the issues based on their type, incidence, severity, and frequency occurrence patterns and potential consequences.

Frequency analysis examines how often a particular issue or non-conformance appears across the quality records. It helps identify recurring problems or systemic issues that may require targeted interventions or process improvements.

Duration analysis looks at the time span over which an issue persists or remains unresolved. It helps prioritize issues based on their longevity and potential impact on quality, safety, or compliance. Issues that have been lingering for an extended period may indicate underlying root causes that need to be addressed promptly.

Impact analysis assesses the potential consequences or risks associated with each identified issue. It considers factors such as the severity of the non-conformance, the potential harm to customers, employees, or the environment, and the financial or reputational implications for the organization.

The system may utilize predefined risk matrices and scoring mechanisms to quantify the impact of each issue. These matrices consider the likelihood and severity of potential outcomes, assigning risk ratings or scores to prioritize the issues based on their criticality.

For example, a quality issue that poses a high risk of customer harm or regulatory non-compliance would be assigned a higher impact score compared to a minor documentation discrepancy.

The results of the frequency, duration, and impact analysis are used to determine the overall risk severity of each identified quality issue 208c. The risk severity provides a comprehensive assessment of the potential threats or consequences associated with the issues.

The risk severity may be calculated based on a combination of factors, including the type, severity, or frequency of occurrence, the duration of the issue, and the potential impact on various aspects of the organization, such as safety, compliance, financial performance, and reputation.

The system may employ proprietary and industry-specific risk assessment algorithms or decision rules to assign severity levels to each issue. These algorithms take into account the quantitative and qualitative data gathered during the previous analysis steps, as well as any predefined risk thresholds or criteria established by the organization.

The risk severity levels may be represented using a scale, such as low, medium, high, or critical, to provide a clear and actionable prioritization of the quality issues. This severity rating helps guide the allocation of resources and the urgency of corrective actions.

In addition to the risk severity, the system generates a risk severity report 208e. This report provides a detailed summary of the identified quality issues, their associated risk levels, and the supporting evidence or justification behind the risk assessments.

The risk severity report may include:

Issue description: A clear and concise description of each identified quality issue, including the relevant details, such as the affected products, processes, or departments.

Risk severity level: The assigned risk severity level for each issue, along with an explanation of the factors contributing to the risk assessment.

Supporting evidence: The specific quality records, data points, or observations that substantiate the risk assessment, providing a traceable and auditable trail.

Recommended actions: Suggestions or guidelines for addressing each quality issue based on its risk severity, such as immediate containment measures, root cause analysis, or process improvements.

The risk severity report may serve as a key communication tool, enabling quality management teams, executives, and other stakeholders to understand the risk, scope and urgency of the identified risks. It provides a consolidated view of the compliance status and helps prioritize risk-based activities, responses, and quality improvement initiatives.

To further contextualize the risk assessment, the system compares the identified quality issues with the organization's compliance history 208d. This step involves analyzing past quality records, audit findings, and corrective and preventive actions to identify any patterns, trends, or recurring issues.

By comparing the current quality issues with historical data, the system can determine if the identified risks are novel or if they represent persistent challenges that have been previously encountered or previous corrective/preventive actions that failed during verification of effectiveness checks. This historical context provides valuable insights into the effectiveness of past corrective and preventive actions and the need for more robust interventions.

The compliance history comparison may involve techniques such as:

Trend analysis: Examining the frequency and severity of similar quality issues over time to identify any upward or downward trends in compliance performance.

Root cause analysis: Investigating the underlying causes of recurring quality and compliance issues to identify systemic weaknesses or gaps in processes, training, or resources.

Benchmarking: Comparing the organization's compliance performance against industry standards, best practices, peer organizations, and/or historical reports to assess relative standing and identify areas for improvement or demonstrate improvement compared to past assessments.

The insights gained from the compliance history comparison are incorporated into the risk severity report, providing a comprehensive view of the organization's quality landscape. This information helps decision-makers prioritize resources, develop targeted improvement strategies, and monitor progress over time.

Referring back to FIG. 3, the analysis of quality compliance assessment results 208 culminates in the classification of each quality record as acceptable or not acceptable based on the risk severity assessment and compliance history comparison.

Records that meet the predefined compliance criteria and fall within acceptable risk thresholds are classified as acceptable. These records demonstrate adherence to quality standards, regulatory requirements, and organizational policies and requirements.

On the other hand, records that exhibit significant non-conformances, high-risk issues, or persistent compliance challenges are classified as not acceptable. These records indicate areas of concern that require immediate attention and corrective/preventive action.

The classification of records as acceptable or not acceptable provides a clear and actionable outcome of the automated compliance review process. It enables quality management teams and management to focus their efforts on the records and activities that pose the greatest risks or require the most urgent interventions.

For records deemed not acceptable, the specific parameters of each identified quality issue are described 209. This description provides a detailed breakdown of the non-conformances, deviations, or deficiencies associated with each record.

The description includes information such as:

Nature of the issue: A clear and concise explanation of the specific quality problem or non-conformance identified in the record.

Affected areas: The specific products, processes, departments, or systems impacted by the quality issue.

Relevant standards or requirements: The specific quality standards, regulations, or organizational policies that the record fails to meet or comply with.

Evidence and observations: The specific data points, measurements, or observations that support the identification of the quality issue.

By providing a detailed description of each quality issue, the system enables a thorough understanding of the scope and nature of the problems identified. This information is crucial for guiding corrective actions, investigations, and improvement initiatives.

Finally, the system generates a comprehensive quality review report 210, as described in FIG. 3. This report consolidates the findings of the automated compliance review process, including the classification of records, the detailed descriptions of quality issues, and the risk severity assessments.

The quality review report serves as a centralized resource for communicating the compliance status, identifying areas of concern, and driving quality improvement efforts. It provides a clear and concise summary of the automated review results, enabling stakeholders at all levels of the organization to understand and oversee risks and act upon the findings.

The report may include various visual elements, such as charts, graphs, and dashboards, to present the information in an intuitive and easily digestible format. It may also include recommendations for corrective actions, process improvements, or further investigations based on the identified quality issues and risk severity levels.

The quality review report is typically shared with key stakeholders, such as quality management teams, executives, and regulatory bodies, through secure electronic distribution channels. It becomes a vital tool for decision-making, compliance monitoring, and continuous improvement initiatives.

Through the automated compliance review process detailed in FIG. 3 and the analysis of compliance assessment results described in FIG. 4, the system leverages the power of LLM and proprietary QRL to identify, assess, and prioritize quality issues with a level of accuracy, consistency, and efficiency that surpasses traditional manual review methods and leads to increased cost and time savings while improving quality and managing risks, real-time.

By providing a comprehensive and data-driven view of the compliance landscape, the system enables organizations to proactively address quality challenges, mitigate risks, and ensure the highest standards of product safety, customer satisfaction, and regulatory adherence.

The integration of LLM and QRL represents a significant advancement in the field of quality management, harnessing the power of artificial intelligence and domain expertise to revolutionize the way organizations approach compliance and continuous improvement.

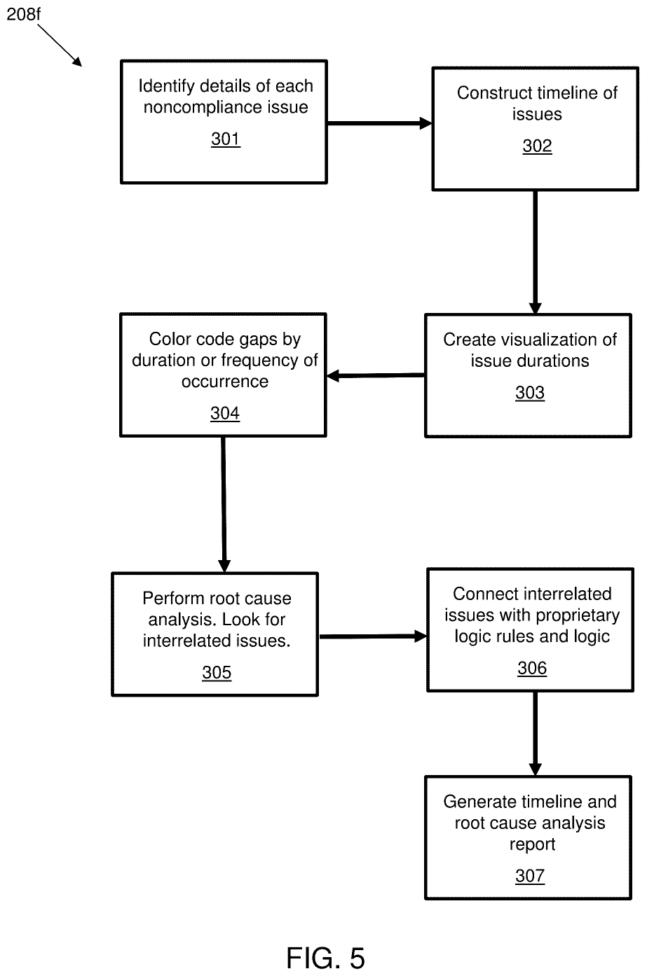

Referring now to FIG. 5, there is shown a continuation of the flowchart from FIG. 4, illustrating the calculation of the final severity of compliance assessment and quality review findings, in accordance with an embodiment of the invention.

The process begins by identifying the details of each noncompliance issue 301. This step involves extracting and compiling all the relevant information associated with each identified issue, providing a comprehensive view of the problem at hand.

The details captured for each noncompliance issue may include:

Date of occurrence: The specific date or time period when the issue was first observed or reported. This information helps establish a temporal context for the issue.

Affected records: The specific quality records, documents, or data sets impacted by the noncompliance issue. This information helps scope the extent of the problem and identify the areas that require remediation.

Issue description: A clear and concise summary of the nature of the noncompliance, including the specific requirements or standards that were violated. This description provides a high-level understanding of the issue and its potential implications.

Severity level: An initial assessment of the severity or criticality of the issue based on predefined criteria or risk assessment matrices. This severity level helps prioritize the issue and determine the urgency of corrective actions.

Responsible parties: The individuals, teams, or departments responsible for addressing, resolving, and overseeing the activities related to the noncompliance issue. This information ensures accountability and facilitates the assignment of corrective and preventive actions and ongoing management and risk oversight.

Current status: An indication of whether the issue is still open or has been resolved. If resolved, the date of resolution is captured. This status tracking helps monitor the progress of issue resolution and identifies any outstanding or overdue items.

The identification of noncompliance issue details is an automated process, leveraging the capabilities of the system described in claim 1. The system uses advanced data extraction and analysis techniques to mine the relevant information from the quality records and populate the issue details.

This automated approach offers several advantages over traditional manual methods:

Efficiency: The system can quickly and accurately extract the necessary details from a large volume of quality records, saving significant time and cost and effort compared to manual review.

Consistency: The automated process ensures that the same set of details is captured for each noncompliance issue, providing a consistent and standardized approach to document review and issue detection and reporting.

Completeness: The system's comprehensive data analysis capabilities help identify all relevant details associated with each issue, minimizing the risk of missing critical information.

Scalability: The automated process can handle a growing volume of quality records and noncompliance issues without compromising the speed or accuracy of detail extraction.

Once the details of each noncompliance issue have been identified, the system may proceed to construct a timeline of the issues 302. This timeline provides a chronological representation of the occurrence, resolution, and potential recurrence of each issue.

The timeline construction process may involve the following steps:

Plotting issue occurrences: Each noncompliance issue is placed on the timeline based on its date of occurrence. If an issue spans multiple dates or time periods, it is represented as a duration bar on the timeline.

Marking issue resolution: If an issue has been resolved, the resolution date is marked on the timeline. This helps visualize the time taken to address and close each issue.

Identifying issue recurrences: If an issue reoccurs after initial resolution, the subsequent occurrences are plotted on the timeline. This helps identify patterns of recurring issues and potential systemic problems.

Aligning related issues: If multiple issues are related or have dependencies, they are visually aligned or connected on the timeline. This helps understand the sequence and relationships between issues.

The timeline construction process leverages the system's ability to review and analyze all available quality records, providing a comprehensive view of the issue landscape. This is a novel feature compared to human auditors who can only review a subset of records due to time and resource constraints.

The comprehensive timeline enables several key benefits:

Holistic view: The timeline provides a big-picture view of the noncompliance issues, allowing stakeholders to understand the overall health and compliance status of the organization.

Trend identification: The chronological representation helps identify trends or patterns in issue occurrence, such as seasonal spikes or recurring issues after specific events.

Gap analysis: The timeline visually highlights gaps in compliance, such as long periods without issue resolution or frequent recurrences of similar issues.

Prioritization: The timeline helps prioritize issues based on their duration, frequency, and potential impact on the organization's compliance posture.

To further enhance the visual communication of issue durations and persistence, the system creates a visualization of the issue durations 303. This visualization complements the timeline by providing a more intuitive and impactful representation of the temporal aspects of noncompliance issues.

The issue duration visualization involves the following elements:

Duration bars: Each issue is represented by a horizontal bar on the timeline, with the length of the bar proportional to the duration of the issue. Longer bars indicate issues that have persisted for an extended period.

Color-coding: The duration bars are color-coded based on predefined thresholds or severity levels. For example, issues with a duration exceeding a certain threshold may be colored red to indicate high criticality, while shorter durations may be colored green or yellow.

Connectors: If an issue has multiple occurrences or recurrences, the corresponding duration bars are connected using lines or arrows. This helps visualize the gaps between occurrences and the overall persistence of the issue.

Tooltips or labels: When hovering over or clicking on a duration bar, additional details about the issue are displayed, such as the specific dates, affected records, and resolution status.

The issue duration visualization offers several benefits:

Quick identification of long-standing issues: The color-coding and length of the duration bars make it easy to spot issues that have been unresolved for an extended period, drawing attention to potential chronic problems.

Comparison and prioritization: The relative lengths of the duration bars allow for quick comparison of issue durations, helping prioritize issues based on their persistence and potential impact.

Communication and reporting: The visualization serves as an effective communication tool, allowing stakeholders to grasp the temporal aspects of noncompliance issues at a glance. It can be included in reports or presentations to convey the urgency and criticality of issues.

To further emphasize the gaps in compliance, the system may automatically color-code the gaps by type, incidence, severity, duration or frequency of occurrence 304. This color-coding scheme may be adapted to draw attention to the most critical or repetitive gaps, facilitating quick identification and prioritization.

The color-coding of compliance gaps involves the following considerations:

Duration-based color-coding: Gaps that persist for a longer duration, indicating a significant period of noncompliance, are assigned a more intense or alarming color, such as red. Shorter gaps may be assigned less intense colors, such as yellow or green, depending on their duration.

Frequency-based color-coding: Gaps that occur frequently, indicating recurring or systemic issues, are assigned a distinct color or pattern. For example, frequently occurring gaps may be colored orange or have a striped pattern to differentiate them from isolated gaps.

Threshold-based color-coding: The color-coding can be based on predefined thresholds or criteria. For example, gaps exceeding a certain duration or frequency threshold may be colored red, while gaps falling below the threshold may be colored differently.

The color-coding of compliance gaps provides several advantages:

Visual prioritization: The color-coding allows for quick visual identification of the most critical or recurring gaps, enabling stakeholders to focus their attention and resources on the highest priority issues.

Pattern recognition: The distinct colors or patterns assigned to frequent gaps help identify potential systemic issues or recurring problems that may require deeper investigation and corrective and preventive action.

Communicating severity: The color-coding communicates the severity or criticality of the compliance gaps, making it easier for stakeholders to understand the potential impact and urgency of addressing them.

By incorporating color-coding into the visualization of compliance gaps, the system enhances the visual impact and informative value of the timeline. It enables stakeholders to quickly grasp the overall compliance status, identify areas of concern, and prioritize corrective and preventive actions.

Next, the system may perform a comprehensive root cause and scope analysis 305 to identify the underlying factors contributing to the noncompliance issues. Root cause and scope analysis is a crucial step in understanding the fundamental reasons behind the issues and their scope, to support the development of appropriate corrective and preventive actions.

The root cause analysis process employed by the system is a novel approach that leverages the expert training rules in the proprietary knowledge base, derived from the expertise of seasoned quality control, quality assurance, and compliance-trained personnel such as auditors. These rules guide the AI LLM (large language model) on the specific questions to ask, the areas to investigate, and the potential root causes to consider during the analysis.

The root cause analysis process involves the following steps:

Data gathering: The system collects and consolidates all relevant data related to the noncompliance issues, including the scope and incidence of affected records, associated processes, personnel involved, and any additional contextual information.

Pattern identification: The AI LLM uses the proprietary QRL to analyze the data to identify patterns, trends, and relationships among the noncompliance issues. It looks for commonalities, such as similar issue descriptions, shared affected item identifiers (i.e. lot numbers, batch IDs, etc.) or personnel performing activities, shared affected records, or recurring timestamps.

Guided questioning: Based on the expert training rules, the AI LLM uses the proprietary QRL to generate specific questions to probe deeper into the identified patterns and potential root causes. These questions may cover aspects such as process deviations, training gaps, equipment failures, workflows and systems, documentation issues, resource allocations, or communication breakdowns.

Contextual analysis: The AI LLM using the proprietary QRL, considers the broader context surrounding the noncompliance issues, such as organizational structure, regional factors or external influences. It examines how these contextual elements may have contributed to or perpetuated the issues.

Causal reasoning: The AI LLM employs the proprietary QRL applies causal reasoning techniques to identify potential cause-and-effect relationships between the identified factors and the noncompliance issues. It determines which factors are the most likely root causes based on the strength of the causal links and the expert training rules.

False positive filtering: The knowledge base contains guardrails to guide the AI LLM in identifying and filtering out potential false positives. These guardrails help differentiate between true root causes and coincidental or superficial associations.

The combination of the expert system and AI-enhanced LLM creates a proprietary and powerful method for conducting root cause analysis. A comprehensive system is an improvement over the limitations of human manual compliance assessments and audits, which typically only review a small subset of records and may miss crucial connections or be influenced by individual biases.

The QRL+AI-driven root cause analysis offers several advantages:

Comprehensive coverage: The system can analyze a vast amount of data considers a wide range of factors, ensuring a thorough exploration of where and in what aspect of activity noncompliance occurred together with what the scope and breadth of noncompliance is, which can assist in more precisely identifying potential root causes.

Consistent and objective analysis: The AI LLM applies the expert QRL training rules consistently across all record reviews and identified and reported noncompliance issues, reducing the variability and subjectivity associated with human analysis.

Identification of systemic issues: The system can identify root causes that span multiple records, processes, or departments, uncovering systemic issues that may be overlooked in manual audits and assessments.

Efficiency and scalability: The automated nature of the root cause analysis allows for quick and efficient processing of large volumes of data, enabling organizations to address issues promptly scale their compliance efforts.

Once the root causes have been identified, the system connects interrelated issues 306 by establishing links between issues that share a common root cause. This step helps uncover the broader impact and relationships among noncompliance issues.

The process of connecting interrelated issues may involve the following:

Root cause mapping: The system maps each noncompliance issue to its identified root causes, creating a network of issues and their underlying factors.

Relationship identification: The AI LLM uses the QRL to analyze the root cause network to identify relationships and dependencies among the issues. It looks for issues that share common root causes, indicating a potential systemic problem or a cascading effect.

Link establishment: The system creates visual links or connections between the interrelated issues on the timeline or in the visualization. These links highlight the shared root causes and the potential impact of one issue on another.

Strength assessment: The system assesses the strength or significance of the relationships between the issues based on factors such as the number of shared root causes, the severity of the issues, and the expert training rules.

The process of connecting interrelated issues provides several benefits:

Holistic understanding: By visualizing the relationships among issues, stakeholders gain a holistic understanding of the compliance landscape and the interconnectedness of problems.

Prioritization and impact assessment: The links between issues help prioritize corrective and preventive actions based on the potential impact and cascading effects of addressing certain root causes.

Systemic issue identification: The identification of interrelated issues highlights systemic problems that may require broader organizational changes or process improvements.

Collaborative problem-solving: The visual representation of issue relationships facilitates collaborative problem-solving by enabling cross-functional teams to understand the dependencies and work together to address the root causes.

To enhance the usability and interactivity of the system, it may provide drilldown capabilities 307. Users can click on individual issues on the timeline or in the visualization to access pertinent details and affected records. This feature allows stakeholders to explore the specifics of each noncompliance issue and gain a deeper understanding of its context.

The drilldown functionality may include the following:

Issue details: When clicking on an issue, users can view a detailed description of the noncompliance, including the specific requirements violated, the severity level, and any associated comments or notes.

Affected records: The system displays a list or summary of the quality records impacted by the selected issue, enabling users to review the specific documents or data points related to the noncompliance.

Root cause information: The drilldown view provides information about the identified root causes for the selected issue, including a description of the underlying factors and any supporting evidence or analysis.

Related issues: The system highlights any interrelated issues connected to the selected issue, allowing users to explore the broader context and potential impact of the noncompliance.

In addition to the drilldown capability, the system offers filtering and customization options 308. Users can filter the timeline or visualization based on various criteria, such as issue severity, type, or affected departments. This allows stakeholders to focus on specific subsets of issues that are most relevant to their roles, teams, processes, or areas of responsibility.

The filtering options may include:

Severity level: Users can filter issues based on their assigned severity level (e.g., critical, high, medium, low) to prioritize attention and resources.

Issue type: Issues can be filtered by their classification or category (e.g., documentation, training, equipment) to identify patterns or trends within specific areas.

Department or process: Users can filter issues based on the affected departments, processes, or functional areas to understand the distribution and impact of noncompliance across the organization. This enables determination of the scope of the issue(s).

Date range: The timeline can be filtered to display issues within a specific date range, enabling users to focus on recent or historical noncompliance events. Chronological tracking of the issue facilitates determination of incidence count, frequency, periodicity, recurrence patterns, and duration.

The filtering and customization options provide several benefits:

Focused analysis: Users can narrow down the scope of analysis to specific areas of interest, reducing information overload and enabling targeted problem-solving.

Role-specific views: Different stakeholders, such as quality managers, department heads, or executives, can customize the view to align with their specific responsibilities and information needs.

Trend identification: By filtering issues based on various criteria, users can identify trends, patterns, or recurring problems within specific domains or time periods.

Comparative analysis: The ability to filter and compare subsets of issues facilitates benchmarking and performance tracking across different departments, processes, or time frames.

Finally, the results of the timeline analysis, root cause identification, and issue connectivity are compiled into a comprehensive report and sent to a local computer for viewing 309. This report provides a detailed and visually intuitive overview of the compliance issues, their durations, interrelationships, and underlying root causes.

The report generation process may involve the following steps:

Data consolidation: The system gathers all the relevant information from the timeline, issue details, root cause analysis, and issue connectivity into a structured format suitable for reporting.

Visualization integration: The report incorporates the visual elements, such as the timeline, issue duration bars, and issue connectivity links, to provide a clear and engaging representation of the compliance status.

Narrative explanation: The report includes a narrative description of the key findings, highlighting the most critical issues, the identified root causes, and the potential impact on the organization's compliance posture.

Recommendations and action items: Based on the analysis and expert training rules, the report provides recommendations and suggested action items for addressing the identified issues and preventing future occurrences.

Distribution and accessibility: The report is securely transmitted to the designated local computer or system, ensuring that it is accessible to the relevant stakeholders for review and action.

The comprehensive report may serve several critical functions:

Communication and awareness: The report effectively communicates the compliance status, issues, and root causes to stakeholders at all levels of the organization, promoting awareness and understanding of the current situation.

Decision support: The detailed information and analysis provided in the report support informed decision-making by highlighting the most pressing issues, the potential impact, and the recommended actions.

Accountability and tracking: The report serves as a formal record of the compliance assessment, enabling stakeholders to track progress, assign responsibilities, and monitor the implementation of corrective actions.

Continuous improvement: The insights and recommendations in the report contribute to the organization's continuous improvement efforts by identifying areas for process enhancements, training needs, or resource allocation.

By leveraging the power of AI and expert knowledge, the system described in FIG. 5 provides a comprehensive and innovative approach to compliance assessment and root cause analysis. It enables organizations to efficiently identify, prioritize, and address noncompliance issues, driving improvements in quality, safety, and overall compliance performance.

The novel combination of timeline visualization, automated issue connectivity, and AI-driven root cause analysis offers a significant advancement over traditional manual quality control, manual audits and compliance assessments. It empowers organizations to proactively manage compliance risks, make data-driven decisions, and foster a culture of continuous improvement.

Through the systematic and scalable analysis of quality records, the identification of interrelated issues, and the pinpointing of underlying root causes, the system enables organizations to build a robust and resilient compliance framework. It equips quality managers, auditors, and executives with the tools and insights necessary to navigate complex compliance landscapes, mitigate risks, and drive sustainable improvements.

The benefits of this AI-powered compliance assessment system extend beyond the immediate identification and resolution of noncompliance issues. By providing a holistic view of the compliance status and the interconnectedness of issues, the system enables organizations to develop proactive strategies for risk management and prevention.

The insights derived from the timeline analysis and root cause identification can inform policy updates, process redesigns, and training initiatives. By addressing the underlying factors contributing to noncompliance, organizations can create a more resilient and compliant environment, reducing the likelihood of future issues arising.

Moreover, the automated nature of the system allows for continuous monitoring and assessment of compliance health. As new quality records are generated and added to the system, the AI algorithms can promptly identify emerging issues, trends, or patterns. This real-time visibility enables organizations to stay ahead of potential compliance risks and take swift corrective actions.

The scalability of the system is another key advantage. As organizations grow and the volume of quality records increases, the AI-powered analysis can keep pace, ensuring that compliance assessment remains thorough and efficient. This scalability is particularly valuable for large enterprises with complex operations spanning multiple sites, departments, or geographies.

The explainable nature of the AI algorithms used in the system is also crucial. The expert training rules and guardrails embedded in the knowledge base ensure that the root cause analysis and issue connectivity are grounded in domain expertise and best practices. This transparency and interpretability build trust in the system's recommendations and facilitate effective collaboration between the AI and human stakeholders.

Furthermore, the integration of the compliance assessment system with existing quality management processes and tools enhances its impact and usability. The system can seamlessly exchange data with other enterprise systems, such as document management platforms, incident reporting tools, or continuous improvement software. This integration enables a streamlined flow of information and a unified approach to compliance management.

The reporting capabilities of the system also play a vital role in driving accountability and continuous improvement. The comprehensive reports generated by the system serve as a single source of truth for compliance status, providing a clear and concise overview for stakeholders at all levels. The visual elements, such as the timeline and issue connectivity diagrams, make the information easily digestible and actionable.

The reports can be customized to meet the specific needs and preferences of different audiences. Quality managers may require detailed technical information and root cause analysis, while executives may prefer high-level summaries and key performance indicators. The flexibility in report generation ensures that the right information reaches the right stakeholders in a format that supports effective decision-making.

Moreover, the reports can be used to track progress over time and measure the effectiveness of corrective actions. By comparing the compliance status before and after interventions, organizations can assess the impact of their improvement initiatives and make data-driven adjustments as needed.

The AI-powered compliance assessment system described in FIG. 5 represents a paradigm shift in how organizations approach quality and compliance management. By leveraging the power of artificial intelligence, expert knowledge, and data-driven insights, the system empowers organizations to proactively identify, prioritize, and address noncompliance issues.

The novel features of the system, such as the timeline visualization, automated issue connectivity, and AI-driven root cause analysis, provide a comprehensive and efficient means of assessing compliance health. The system enables organizations to move beyond reactive problem-solving and embrace a proactive approach to compliance management.

By implementing this system, organizations can foster a culture of continuous improvement, where compliance is not just a regulatory requirement but a strategic imperative. The insights and recommendations generated by the system can drive organizational change, process optimization, and workforce development, ultimately leading to enhanced quality, safety, and customer satisfaction.

The benefits of the AI-powered compliance assessment system extend beyond the boundaries of individual organizations. By promoting a more robust and compliant ecosystem, the system contributes to the overall integrity and trust in the industries it serves. It enables organizations to demonstrate their commitment to quality and compliance, strengthening their reputation and competitive position in the market.

As the system continues to evolve and learn from the growing volume of quality records and expert feedback, its effectiveness and accuracy will only improve over time. The continuous refinement of the AI algorithms and the expansion of the knowledge base will enable the system to adapt to emerging compliance challenges and industry-specific requirements.

The AI-powered compliance assessment system described in FIG. 5 represents a transformative solution for organizations seeking to elevate their quality and compliance management practices. By harnessing the power of artificial intelligence, expert knowledge, and data-driven insights, the system enables organizations to build a robust and resilient compliance framework, drive continuous improvement, and achieve operational excellence.

The system's novel features, scalability, and integration capabilities make it a valuable tool for organizations of all sizes and industries. It empowers quality managers, auditors, and executives to make informed decisions, prioritize resources, and proactively address compliance risks.

As organizations navigate an increasingly complex and regulated business landscape, the adoption of AI-powered compliance assessment systems will become a critical success factor. Those who embrace this innovative approach will be well-positioned to meet the evolving demands of customers, regulators, and other stakeholders, while driving sustainable growth and long-term success.

Broadly speaking, the novel method for automated review of quality records may include the following steps:
operating a computer to access a plurality of electronic quality records,
normalizing at least one electronic quality record of the plurality of electronic quality records to facilitate computer analysis thereof,
sorting all electronic quality records into a predefined plurality of electronic quality record categories,
operating the computer to automatically review at least some of the electronic quality records in at least some of the plurality of electronic quality record categories using a plurality of predefined sets of quality rules and logic, wherein each electronic quality record category is associated with a corresponding set of quality rules and logic, and
classifying every electronic quality record reviewed in step (d) as acceptable or not acceptable.

Step (a) may further comprise a step of transforming non-text data formats contained in electronic quality records to machine-readable text. The non-text data formats may include one or more of the following:
images, wherein the transforming step comprises applying optical character recognition (OCR) techniques to extract text from the images,
scanned documents, wherein the transforming step comprises applying intelligent document recognition (IDR) techniques to identify and extract relevant text and data fields from the scanned documents,
handwritten notes, wherein the transforming step comprises applying handwriting recognition algorithms to convert the handwritten text into machine-readable text,
audio files, wherein the transforming step comprises applying speech recognition algorithms to transcribe the audio content into written text,
video files, wherein the transforming step comprises applying video analysis techniques to identify and extract relevant text and metadata from the video frames, and
structured data formats, such as spreadsheets or databases, wherein the transforming step comprises parsing and extracting the relevant data fields and values into a standardized machine-readable format.

Furthermore, in step (a), the step of transforming may include a step of transforming digital images, digital audio, and digital video contained in electronic quality records to a machine-readable text:
transforming digital images comprises applying advanced image processing techniques, such as object detection, image segmentation, and pattern recognition, to identify and extract relevant text, symbols, and contextual information from the images,
transforming digital audio comprises employing natural language processing (NLP) techniques, such as named entity recognition, sentiment analysis, and topic modeling, to derive meaningful insights and summarize the audio content in written form,
transforming digital video comprises utilizing multimodal analysis techniques that combine computer vision, speech recognition, and NLP to comprehensively process and extract actionable information from the video footage,
the transforming step includes preprocessing the digital images, audio, and video to enhance their quality and suitability for text extraction, such as noise reduction, contrast enhancement, and audio/video normalization, and
the machine-readable text output from the transforming step is structured and formatted in a standardized manner, such as JSON or XML, to facilitate seamless integration with the subsequent steps of the quality records review process.

Step (c) may further include a step of identifying a type of at least some of the electronic quality records before the step of sorting thereof into the predefined plurality of electronic quality record categories:
the identification of the electronic quality record type is performed using a combination of rule-based and machine learning techniques, such as document classification algorithms and natural language understanding (NLU) models,
the rule-based techniques involve analyzing the structure, format, and content of the electronic quality records against predefined templates, keywords, and regular expressions to determine their type,
the machine learning techniques involve training classifiers on a labeled dataset of electronic quality records, where the classifiers learn to recognize patterns and features associated with different record types,
the identification step takes into account the metadata associated with the electronic quality records, such as file names, timestamps, and author information, to aid in the accurate determination of the record type,
in cases where the identification step yields ambiguous or conflicting results, the method employs confidence scoring and threshold-based decision making to assign the most likely record type,
the identified record types are mapped to the predefined electronic quality record categories using a comprehensive ontology or taxonomy that defines the relationships and hierarchies between different types and categories,
the identification step is performed iteratively and dynamically, allowing for the continuous refinement and updating of the record type classification based on new data and feedback from the quality records review process, and
the output of the identification step is a labeled set of electronic quality records, where each record is associated with one or more predefined categories, enabling efficient and accurate sorting in the subsequent step.

Step (c) may further include a step of rule-based data mapping, wherein at least some of the electronic quality records from step (b) may be sorted into respective electronic quality record categories. The rule-based data mapping step may involve defining a set of mapping rules that specify the criteria and conditions for assigning electronic quality records to specific categories. The mapping rules may be based on the content, structure, and metadata of the electronic quality records, as well as the predefined categories and their associated attributes. The mapping rules may be implemented using a combination of conditional statements, regular expressions, and logical operators to evaluate the electronic quality records and determine their appropriate categories. The mapping rules may be organized into a hierarchical structure, allowing for the application of more specific or granular rules based on the outcome of higher-level rules. The mapping process may include a mechanism for handling electronic quality records that do not match any of the predefined categories, such as creating new categories dynamically or flagging the records for manual review. The rule-based data mapping step may be performed in real-time as new electronic quality records are added to the system, ensuring that the categorization remains up-to-date and consistent. The mapping rules may be versioned and auditable, allowing for the tracking of changes and the ability to revert to previous versions if needed. Finally, the output of the rule-based data mapping step may be a structured and categorized set of electronic quality records that can be efficiently processed and analyzed in the subsequent steps of the quality records review process.

In step (d), the step of automatically reviewing the at least some of the electronic quality records may be conducted using a predefined acceptance criterion, such as a set of rules, thresholds, and conditions that determine whether an electronic quality record meets the required quality standards. It may be established based on industry best practices, regulatory requirements, and organizational policies and cover various aspects of the electronic quality records, such as completeness, accuracy, consistency, and timeliness. The predefined acceptance criterion may be specific to each corresponding electronic quality record category, considering the unique characteristics and requirements of each category. It may be implemented using a combination of quantitative and qualitative measures, such as data validation checks, statistical analysis, and content analysis and may include a scoring or grading system that assigns a numerical value or a pass/fail status to each electronic quality record based on its level of compliance with the criterion. Furthermore, the predefined acceptance criterion may be regularly reviewed and updated to ensure its relevance and effectiveness in assessing the quality of the electronic quality records. The output of the step of automatically reviewing the electronic quality records using the predefined acceptance criterion may be a set of classified records, where each record is labeled as acceptable or not acceptable based on its adherence to the criterion.

Step (e) of classifying may be conducted by comparing each electronic quality record against the predefined acceptance criterion. The comparison step may involve evaluating the content, structure, and metadata of each electronic quality record against the specific rules, thresholds, and conditions defined in the predefined acceptance criterion. It may utilize various techniques, such as pattern matching, data validation, and statistical analysis, to assess the compliance of the electronic quality records with the acceptance criterion. Moreover, the comparison step may take into account the specific requirements and characteristics of each electronic quality record category, applying the relevant subset of the acceptance criterion based on the category of the record being evaluated. A detailed report or log may be generated that captures the results of the evaluation, including any discrepancies, errors, or non-conformances identified during the process. The comparison step may include a mechanism for handling electronic quality records that partially meet the acceptance criterion, such as assigning a weighted score or a conditional acceptance status. It may be performed iteratively, allowing for the re-evaluation of electronic quality records that have undergone corrective actions or revisions based on the initial classification. The comparison step may be optimized for performance and scalability, employing techniques such as parallel processing, caching, and load balancing to handle large volumes of electronic quality records efficiently. The output of the comparison step may be a classified set of electronic quality records, where each record is labeled as acceptable or not acceptable based on its adherence to the predefined acceptance criterion, along with detailed information about the specific criteria that were met or violated.

Step (f) may be also included in the method, this step involves generating a report listing a result of classification of at least some of the electronic quality records as acceptable or not acceptable and at least one specific parameter that caused each respective classified electronic quality record to be determined as not acceptable. Generating the report may involve consolidating and summarizing the results of the classification process and providing a clear and concise overview of the quality status of the electronic quality records. The report may include a tabular or graphical representation of the number and percentage of electronic quality records classified as acceptable or not acceptable, broken down by category or other relevant attributes. For each electronic quality record classified as not acceptable, the report may provide a detailed description of the specific parameters or criteria that caused the record to fail the acceptance criterion. The specific parameters listed in the report may include, for example, missing or incomplete data fields, data format or type mismatches, data value errors, inconsistencies with respect to other records or external references, and non-compliance with regulatory or organizational requirements. The report may include recommendations or suggested corrective actions for addressing the identified issues and bringing the not acceptable electronic quality records into compliance with the acceptance criterion. A mechanism for prioritizing the not acceptable electronic quality records may be proposed based on their criticality, risk level, or potential impact on the organization's operations or compliance posture. The report may be designed to be easily understandable and actionable, using clear language, visual aids, and contextual information to convey the findings and recommendations effectively to a diverse audience of stakeholders. It may be generated automatically and can be distributed electronically to the relevant parties, such as quality managers, auditors, and process owners, for further analysis and action. The report may serve as a key artifact in the quality records review process, providing a traceable and auditable record of the classification results and the basis for any corrective actions or process improvements undertaken by the organization.

The computer-implemented method for automated review of quality records may further include a step of providing at least two severity levels of a risk of a predefined negative outcome for a subject associated with the electronic quality records. The severity levels may be defined based on the potential impact or consequences of the predefined negative outcome on the subject, such as safety, quality, compliance, or financial implications. They may be determined using a risk assessment framework that takes into account factors such as the likelihood of the negative outcome occurring, the magnitude of the potential harm, and the vulnerability of the subject. They may also be specific to each electronic quality record category and are aligned with the predefined acceptance criterion for that category and may be assigned to each electronic quality record during the classification process, based on the extent to which the record deviates from the acceptance criterion and the associated risk of the predefined negative outcome. The severity levels may be represented using a standardized scale or nomenclature, such as low, medium, high, or critical, to ensure consistency and comparability across different electronic quality records and categories. They may be used to prioritize the remediation and corrective actions for the not acceptable electronic quality records, with higher severity levels indicating a greater urgency and priority for action. In embodiments, they may be dynamically updated based on new information or changes in the risk profile of the subject, ensuring that the risk assessment remains current and relevant. The severity levels may be communicated to the relevant stakeholders, such as quality managers, risk managers, and subject matter experts, to facilitate informed decision-making and resource allocation for risk mitigation and quality improvement initiatives. Incorporation of severity levels into the automated quality records review process enables a more comprehensive and risk-based approach to quality management, aligning the organization's efforts with the most critical and impactful areas of concern.

Step (f) may further comprise a step of stratifying not acceptable electronic quality records from step (e) according to their corresponding severity of risk, such as grouping or categorizing the not acceptable electronic quality records based on their assigned severity levels. This may enable a more granular and focused analysis of the not acceptable records, allowing for the identification of patterns, trends, or commonalities within each severity level, and may facilitate the prioritization and allocation of resources for corrective actions and quality improvement initiatives, ensuring that the most severe and critical issues are addressed first. The stratification step may also include the creation of visual aids, such as risk matrices or heat maps, to provide a clear and concise representation of the distribution and concentration of not acceptable records across the different severity levels. It may incorporate statistical analysis techniques, such as Pareto analysis or Poisson distribution fitting, to identify the most significant contributors to the overall risk profile and to guide the development of targeted risk mitigation strategies. Furthermore, it may enable the setting of risk thresholds or tolerance levels for each severity level, triggering automated alerts or escalations when the number or proportion of not acceptable records within a severity level exceeds the defined threshold. This step may be performed dynamically, with the grouping and categorization of not acceptable records being updated in real-time as new records are classified and severity levels are assigned. The output of the stratification step may be a structured and prioritized set of not acceptable electronic quality records, grouped by severity level, that can be used to drive risk-based decision-making and continuous improvement efforts.

In other embodiments, step (f) may further comprise a step of providing a timeline of occurrence of at least some not acceptable electronic quality records. Such timeline may involve organizing and presenting the not acceptable electronic quality records in a chronological sequence based on their date and time of creation, modification, or classification. It may provide a visual and intuitive representation of the temporal distribution and progression of not acceptable records over a defined period, such as days, weeks, months, or years. As such, the timeline of occurrence may enable the identification of patterns, trends, or seasonality in the occurrence of not acceptable records, such as increased frequency during certain periods or cyclical variations. It may also facilitate the correlation of not acceptable records with other relevant events or factors, such as changes in processes, personnel, or external circumstances, to identify potential causal relationships or contributing factors. The timeline of occurrence may include the ability to filter, zoom, or drill down into specific time periods or subsets of not acceptable records, allowing for a more focused and detailed analysis of the temporal data. It may incorporate statistical process control (SPC) techniques, such as control charts or cumulative sum (CUSUM) plots, to monitor the stability and variability of the occurrence of not acceptable records over time and to detect significant deviations or anomalies. The timeline of occurrence step may enable the forecasting or projection of future trends in the occurrence of not acceptable records, based on historical data and statistical modeling techniques, to support proactive risk management and resource planning. It may be updated dynamically as new not acceptable records are identified, ensuring that the temporal analysis remains current and relevant. The output of the timeline of occurrence step may be a visual and interactive representation of the chronological distribution of not acceptable electronic quality records, along with associated insights and analytics, that can be used to support data-driven decision-making and continuous improvement initiatives.

The method of the invention may further comprise a step of analyzing the timeline of occurrence of at least some not acceptable electronic quality records to identify chronological patterns, or repetitive occurrence of compliance issues, or interdependent sequences of compliance issues. This analysis may involve applying advanced data mining, machine learning, and pattern recognition techniques to the timeline of occurrence data to uncover hidden patterns, relationships, and dependencies among the not acceptable electronic quality records. The analysis step may include the use of time series analysis methods, such as autocorrelation, cross-correlation, or dynamic time warping, to identify significant temporal patterns or periodicities in the occurrence of not acceptable records. It may incorporate clustering and association rule mining algorithms, such as k-means, hierarchical clustering, or a priori algorithms, to group similar not acceptable records based on their temporal proximity, co-occurrence, or sequence, and to discover frequent item sets or association rules that indicate strong relationships or dependencies among the records. The analysis step may employ anomaly detection and outlier analysis techniques, such as distance-based, density-based, or model-based methods, to identify unusual or unexpected occurrences of not acceptable records that deviate significantly from the normal temporal patterns. It may furthermore include the use of graph-based and network analysis techniques, such as social network analysis or graph mining, to visualize and explore the complex web of relationships and interdependencies among the not acceptable records, and to identify key nodes, hubs, or influencers that play a central role in the propagation or amplification of compliance issues.

The analysis step may incorporate text mining and natural language processing (NLP) techniques, such as topic modeling, sentiment analysis, or named entity recognition, to extract and analyze the unstructured textual data associated with the not acceptable records, such as comments, descriptions, or narratives, and to identify common themes, issues, or trends that may not be apparent from the structured data alone. It may enable the simulation and modeling of different scenarios or interventions, based on the identified patterns and dependencies, to predict the potential impact or effectiveness of different corrective actions or quality improvement strategies. The analysis step may be performed iteratively and continuously, with the results being used to refine and improve the automated quality records review process, as well as to inform the development of more targeted and effective risk management and compliance strategies. The output of the analysis step may be a set of actionable insights, recommendations, and predictive models that can be used to drive proactive and data-driven decision-making, as well as to support the development of more resilient and adaptive quality management systems.

An additional step of forecasting future occurrences of compliance issues may be provided based on the analysis of the timeline of occurrence of at least some not acceptable electronic quality records. The forecasting step may involve the application of predictive analytics and machine learning techniques to the historical data and identified patterns of not acceptable electronic quality records to generate probabilistic estimates or confidence intervals for the likelihood, frequency, and severity of future compliance issues. It may include the use of time series forecasting methods, such as exponential smoothing, autoregressive integrated moving average (ARIMA), or long short-term memory (LSTM) neural networks, to model and extrapolate the temporal trends and dependencies in the occurrence of not acceptable records.

The forecasting step may incorporate regression analysis and statistical inference techniques, such as linear regression, logistic regression, or Bayesian inference, to identify and quantify the significant predictors or risk factors that contribute to the occurrence of not acceptable records, and to estimate their relative importance or impact. It may employ ensemble modeling and model stacking techniques, such as random forests, gradient boosting machines, or stacked generalization, to combine and leverage the strengths of multiple predictive models, and to improve the robustness and accuracy of the forecasts. This step may include the use of transfer learning and domain adaptation techniques to leverage the knowledge and insights gained from other relevant domains, industries, or datasets, and to improve the generalizability and applicability of the predictive models to new or unseen quality records. It may also incorporate sensitivity analysis and uncertainty quantification techniques, such as Monte Carlo simulation or probabilistic graphical models, to assess the impact of different assumptions, parameters, or scenarios on the forecasted outcomes, and to provide a measure of the uncertainty or confidence associated with the predictions.

The forecasting step may enable the development of risk-based monitoring and early warning systems that can alert quality managers or compliance officers to potential issues or threats before they escalate or cause significant harm, and that can trigger proactive interventions or corrective actions. It may be performed continuously and dynamically, with the predictive models being updated and refined as new data becomes available, and with the forecasts being adjusted based on feedback or validation from actual outcomes. The output of the forecasting step may be a set of probabilistic predictions, risk scores, or early warning indicators that can be used to inform risk-based decision-making, resource allocation, and quality improvement planning, as well as to support the development of more proactive and resilient quality management strategies.

### Advantages of the Invention

The invention can review hundreds of quality records in a matter of seconds with an issue accuracy detection of 96 to 100%. The present invention offers significant advantages over traditional human-based auditing methods. While human auditors are constrained by the sheer volume of records they can manually review in a given timeframe, this automated system leverages the power of large language models and proprietary expert logic to process and analyze vast amounts of data with unparalleled speed and efficiency. The variability in expertise and experience among human auditors can result in inconsistent and subjective assessments, whereas the automated system's consistent application of expert-derived rules and logic ensures objective and reproducible results across all records. Human auditors often struggle to identify complex patterns, trends, and relationships across large datasets due to cognitive limitations, but the system's advanced algorithms can easily detect such connections, enabling it to uncover systemic issues and forecast potential risks that would otherwise go unnoticed. The automated nature of the system allows for continuous real-time monitoring and analysis of quality records, whereas manual audits are typically performed periodically, leaving gaps in oversight where issues can remain undetected. Lastly, the system's scalable architecture and cloud-based processing capabilities enable it to handle exponentially growing data volumes without compromising speed or depth of analysis, a feat that would be infeasible for human auditors to match.

It is contemplated that any embodiment discussed in this specification can be implemented with respect to any method of the invention, and vice versa. It will be also understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference. Incorporation by reference is limited such that no subject matter is incorporated that is contrary to the explicit disclosure herein, no claims included in the documents are incorporated by reference herein, and any definitions provided in the documents are not incorporated by reference herein unless expressly included herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least +1, 2, 3, 4, 5, 6, 7, 10, 12, 15, 20 or 25%.

All of the devices and/or methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A computer-implemented method for automated review of quality records comprising contextual non-text data formats with semantic meaning, the method comprising the following steps:
a. operating a computer to access a plurality of electronic quality records,
b. normalizing at least one electronic quality record of the plurality of electronic quality records to facilitate computer analysis thereof,
c. sorting all electronic quality records into a predefined plurality of electronic quality record categories,
d. operating the computer to automatically review at least some of the electronic quality records in at least some of the plurality of electronic quality record categories using a plurality of predefined sets of quality rules and logic, wherein each electronic quality record category is associated with a corresponding set of quality rules and logic, and
e. classifying every electronic quality record reviewed in step (d) as acceptable or not acceptable.

2. The computer-implemented method for automated review of quality records, as in claim 1, wherein step (a) further comprises a step of transforming the contextual semantic meaning of non-text data formats contained in electronic quality records to machine-readable text.

3. The computer-implemented method for automated review of quality records, as in claim 2, wherein the quality records comprise digital images, digital audio, or digital video contained therein, and wherein in step (a), the step of transforming further comprises a step of transforming contextual semantic meaning of digital images, digital audio, and digital video contained in electronic quality records to a machine-readable text.

4. The computer-implemented method for automated review of quality records, as in claim 2, wherein step (c) further comprises a step of identifying a type of at least some of the electronic quality records before the step of sorting thereof into the predefined plurality of electronic quality record categories.

5. The computer-implemented method for automated review of quality records, as in claim 4, wherein step (c) further comprises a step of rule-based data mapping, wherein at least some of the electronic quality records from step (b) are sorted into respective electronic quality record categories.

6. The computer-implemented method for automated review of quality records, as in claim 1, wherein in step (d), the step of automatically reviewing the at least some of the electronic quality records is conducted using a predefined acceptance criterion.

7. The computer-implemented method for automated review of quality records, as in claim 6, wherein the predefined acceptance criterion is specific to each corresponding electronic quality records category.

8. The computer-implemented method for automated review of quality records, as in claim 6, wherein step (e) of classifying is conducted by comparing each electronic quality record against the predefined acceptance criterion.

9. The computer-implemented method for automated review of quality records, as in claim 8, further comprising a step (f) of generating a report listing a result of classification of at least some of the electronic quality records as acceptable or not acceptable and at least one specific parameter that caused each respective classified electronic quality record to be determined as not acceptable.

10. The computer-implemented method for automated review of quality records, as in claim 1, further comprising a step of providing at least two severity levels of a risk of a predefined negative outcome for a subject associated with the electronic quality records.

11. The computer-implemented method for automated review of quality records, as in claim 10, wherein step (f) further comprises a step of stratifying not acceptable electronic quality records from step (e) according to their corresponding severity of risk.

12. The computer-implemented method for automated review of quality records, as in claim 9, wherein step (f) further comprises a step of providing a timeline of occurrence of at least some not acceptable electronic quality records.

13. The computer-implemented method for automated review of quality records, as in claim 12, further comprising a step of analyzing the timeline of occurrence of at least some not acceptable electronic quality records to identify chronological patterns, or repetitive occurrence of compliance issues, or interdependent sequences of compliance issues.

14. The computer-implemented method for automated review of quality records, as in claim 13, further comprising a step of forecasting future occurrences of compliance issues.

15. The computer-implemented method for automated review of quality records, as in claim 1, wherein step (d) further comprises a step of cross-referencing interconnected quality records.
